(19) United States
(12) Patent Application Publication
(10) Pub. No.: US 2012/0216875 A1
(43) Pub. Date: Aug. 30, 2012

(54) METHODS AND SYSTEMS FOR PRODUCING, TRADING AND TRANSPORTING WATER

(76) Inventors: Allen Szydlowski, Santiago (CL); Ian Szydlowski, Santiago (CL); Mickey Fouts, centennial, CO (US)

(21) Appl. No.: 13/222,940

(22) Filed: Aug. 31, 2011

Related U.S. Application Data
(60) Provisional application No. 61/378,811, filed on Aug. 31, 2010.
(60) Provisional application No. 61/511,208, filed on Jul. 25, 2011.

(51) Int. Cl. C02F 1/44; C02F 1/42; F17D 1/00; C02F 1/52; C02F 1/66; C02F 1/78; B01D 37/00; B01D 43/00

(52) U.S. Cl. 137/2; 210/767; 210/660; 210/787; 210/652; 210/800; 210/702; 210/749; 210/760

(57) ABSTRACT

Methods and systems for producing, trading, transporting, and storing commodities are disclosed. More specifically, methods and systems for producing, trading, transporting, and storing large quantities of water having specific characteristics are provided. Methods for transferring title and trading commodities in the form of water are disclosed. Various transport systems are disclosed, including devices and methods for utilizing preexisting vessels to carry different liquid cargoes which should not contact one another.

### RELATED APPLICATIONS

This application claims the benefit of U.S. Provisional Patent Application Ser. No. 61/378,811, filed Aug. 31, 2010, entitled “Method and System for Trading Water”; and U.S. Provisional Patent Application Ser. No. 61/511,208, filed Jul. 25, 2011, entitled “Method and System for Conveying Water on Oil Tanker Ships to Deliver Drinkable Water to Destinations”; both of which are hereby expressly incorporated by reference in their entirety.

### BACKGROUND

Water is the most abundant compound in the human body, making up from 50% to 80% of the human body. Thus, water is essential for life. Without water, a person will die of dehydration within a few days. Thus, clean drinking water is a valuable commodity. Moreover, as the world's population has grown from about 2.5 billion in the early 20th century to around 7 billion today (U.S. Census Bureau, International Database, http://www.census.gov/ipc/www/idb/worldpopinfo.php), sources of clean drinking water have become even more valuable. As the world's population continues to grow, the need for water will only increase. Thus, water has been called the new oil, a resource long squandered, increasingly in demand and hence more expensive, and soon to be overwhelmed by unquenchable demand.

While a little more than 70% of the Earth's surface is covered by water, much of it is undrinkable (The Hydrologic Cycle, United States Geological Survey Pamphlet, U.S. Department of the Interior, 1984). In fact, in its natural state, much of the world's water is unsuitable for most human needs. 97% of all water on the planet is found in the oceans and has a salt content of greater than 30,000 milligrams per liter (mg/L) (Gleick, P. H. (2000), The World's Water 2000-2001, the biennial report on freshwater resources, Island Press, Washington, D.C., USA.).

While methods exist for the purification and desalination of water in order to produce potable and commercially appealing water, (e.g., reverse-osmosis), many of these methods suffer from the drawbacks of high production costs, carbon emissions from the facilities in which they take place, and a significant level of waste water per volume of resulting potable water. With regard to costs, one study concluded that you would need to lift water by 2000 m, or transport it over more than 1600 km (approximately 1000 miles) to get transport costs equal to the desalination costs (Zhou, Y., Tol, R. S. J., Evaluating the costs of desalination and water, (Working paper), December, 2004, via http://www.uni-hamburg.de/Wiss/FB/15/Sustainability/DesalinationFNU41_revised.pdf. Moreover, these methods have also been criticized for the strain they put on natural aquifers. In coastal regions with groundwater aquifers underlain by saline layers, concerns of saltwater encroachment exist where the over-burdening of freshwater aquifers creates a pressure differential that allows heavy concentrations of salt water to infiltrate the drinking supply.

In addition to the drawbacks discussed above, purification and desalination of water to remove undesired contents such as harmful bacteria and heavy metals, typically is an energy-intensive process. In addition to the raw energy consumption required to produce clean water, it is estimated that at least twice the amount water is used in the production process than is actually bottled. In other words, one liter of bottled water represents three liters of water consumed. It has also been estimated that tens of millions of barrels of oil were required to generate the energy needed to produce the volume of bottled water consumed in the United States in 2007.

In addition to the numerous environmental concerns surrounding the current methods of procuring potable water, various health concerns are present as well. Concerns over undesirable foreign contents in municipal water supplies have forced many consumers to balance the aforementioned environmental risks with the perhaps more personal and immediate concerns posed by these health risks. Contaminants such as heavy metals, including transition metals, metalloids, lanthanoids, and actinides (e.g. Mercury, Lead, Chromium, etc.), PCBs (polychlorinated biphenyls), and pesticides frequently occur in water supplies of even advanced regions. The primary causes of these contamination concerns, aging water distribution infrastructure and pollution, are significant public works concerns that will require significant time and cost to update and repair.

From the discussion above it is clear that for much of the world, the seas are not a viable option for obtaining water. Of the about 3% of water that is not salty, approximately 2% is frozen at the poles or in glaciers, leaving about 1% of the water on the Earth available for use (Gleick, P. H., 1996: Water resources. In Encyclopedia of Climate and Weather, ed. by S. H. Schneider, Oxford University Press, New York, vol. 2, pp. 817-823). This water is divided amongst underground aquifers, lakes, rivers, reservoirs and or course, rain. While these are useful sources of water, overuse and political aims have led to aquifers falling, reservoirs drying up and rivers no longer flowing to the sea. In fact, some have predicted that wars will soon be fought over access to water, just as wars over oil played a major role in 20^{th} century history (Solomon, Steven, Water: The Epic Struggle for Wealth, Power and Civilization, New York, HarperCollins Publishers, 2010). Moreover, climate change threatens to make these problems worse.

In addition to the increasing need for sources of fresh drinking water, with increasing interest in healthier lifestyles has come increasing consumer demand for pure drinking water. This is evidenced by the growth in the bottled water business. Thirty years ago, the bottled water industry barely existed. In 2007, Americans spent approximately $16 billion on bottled water (Fast Company, Issue 117, July, 2007), and industry sales are growing at about 8% annually (King, Mike, Bottled Water-Global Industry Guide—New Research Report on Companies and Markets, July, 2008, via http://www.pr-inside.com/bottled-water-global-industry-guide-r688919.htm). Additionally, over the last decade, specialty waters, such as vitamin water, were one of the fastest growing health tends. Clearly then, consumers are willing to pay for water having unique, desirable characteristics.

As previously noted, approximately 70% of the planets fresh water is frozen in ice caps or glaciers. Thus these ice caps and glaciers represent a potential source of fresh water. Furthermore, because of the process by which ice caps and glaciers form, and because of their age, water stored in ice caps and glaciers was frozen in place so long ago that it has unique properties not present in surface water. Inland ice and glaciers are formed by yearly snowfall. Snowfall accumulates and compresses in ice shelves over the course of many years to depths reaching over 4,000 meters in some areas. As the ice layers are compressed, and in the course of thousands of years, the ice moves towards ice rims and glaciers or other terminal points of the ice shelves. Glacial ice advances then retreats from year to year depending upon the climate around the glacier and typical snow accumulation. Glacier movements and shape shifting occur over very long periods of time (i.e., hundreds to thousands of years), but within historic memory, such transformations in fewer than 100 years are not known. Thus, these frozen bodies of water have existed, as mentioned above, for thousands upon thousands of years. In the case of the Antarctic ice sheet, it has an age of over 40 million years.

The use of inland ice as a source of a drinking water resource has been appreciated for years and, in fact, there are several companies that sell water as originating from glaciers. However, known methods have been disadvantageous, because some of the natural purity of the ice has been lost in the preparation of the ice as drinking water, after ice has been taken out from its natural occurrence, such as an iceberg. It has been necessary to melt the ice and then bottle or pack the water in containers permitting transport and distribution of the water to consumers.

In addition to being sources of fresh water, ice caps and glaciers have heretofore unappreciated characteristics. Because such ice was formed far away in time and geography from modern day pollutants, it is extremely pure with regard to such pollutants. Additionally, because methods exist for obtaining and dating ice from various depths, it is possible to obtain water from a specific time period. Consumers may readily appreciate being able to obtain water in the form it existed at the time of Shakespeare, King Arthur, or Jesus, for example.

Other unappreciated advantages can be obtained as well. For example, in recent years, groundbreaking research has yielded evidence of the existence of extraterrestrial components within terrestrial ice, theorized to have been deposited by amino acid-bearing comets that collided with Earth approximately four billion years ago. In 2004, a collection of high speed dust samples taken from the comet Wild-2 by the NASA Stardust probe revealed the existence of glycine, a basic component of proteins, within the comet. The existence of these components in the Wild-2 comet provides much of the basis for the theory that the building blocks for life on Earth were delivered by meteorite and comet impacts. These components have also been found on Earth, preserved in glacial ice in a similar manner as to how they are preserved in frozen comets. It is known that amino acids are crucial elements of life as they foam the basis of proteins, which are linear chains of amino acids. Accordingly, credible evidence exists to state a theory that the early origins of life on Earth are present in current polar and non-polar ice sheets.

While methods of obtaining or producing pure water may be known, distribution of such water to regions where it is needed most remains problematic. Indeed, many areas in need of a reliable water supply do not have the availability of the resource itself to even reap the benefits of purification technologies. At the same time, however, a few specific regions of the Earth have abundant supplies of fresh, clean, and safe water which offer the potential to alleviate demands for water by utilizing the appropriate means for conveyance.

Devices and methods for transporting large volumes of water to distant regions of the Earth have proved costly and inefficient. For example, filtration, purification, and bottling of water for transportation and consumption have become a subject of scrutiny in recent years. In addition to the raw energy consumption required to produce clean water, it is estimated that at least twice the amount water is used in the production process than is actually bottled. In other words, one liter of bottled water may represent as much as three liters of water consumed. It has also been estimated that tens of millions of barrels of oil were required to generate the energy needed to produce the volume of bottled water consumed in the United States in 2007. Furthermore, the production and transportation costs of these methods are proving to be more and more taxing upon our planet's already strained natural resources. Recent research has also revealed that one common method for transporting water and drinking liquids, containment via plastic bottles, poses a variety of health and environmental risks. It is estimated that approximately 70 million plastic bottles of water are consumed daily in the United States alone. In addition to the obvious strain that this puts on landfills and natural resources, many of these bottles may also contain Bisphenol (“BPA”) which may pose health risks to humans. Even bottles that do not contain BPA pose the risk of leaching other chemicals into the contained water or fluid. While bottled water is not without its benefits, it is often desirable to reduce the amount of bottles used or the duration which water or liquid is stored in the bottles.

Moreover, current distribution systems are not responsive to constantly fluctuating demands for water. That is, the water is first bottled at a source, usually a bottling plant, after which it is shipped to warehouses and then on to the point of final sale. Thus, volumes of water are shipped based on estimates of sales with the result that too much, or too little, water might be shipped. Thus water may sit for long periods of time prior to consumption, leading to leaching of container components and off tastes. Moreover, all of the water supplied at the bottling plant is the same, meaning that the customer has no ability to obtain water having a desired, special characteristic. Thus, currently there are no methods of obtaining and distributing inland ice water in its pure form. Moreover, no method currently exists for economically distributing inland ice water in an on-demand fashion, based on need and desirability of specific characteristics.

Accordingly, a long felt but unsolved need exists for a method and system that can be economically employed to contain and convey pure and safe drinking water from various regions of the Earth to those having a need or demand for the same. Additionally, a long felt but unsolved need exists for a method and system that can be economically employed to procure waters having some of the above reference positive attributes without including undesired components. A long felt and unmet need further exists with respect to systems and methods for economically conveying, transporting, trading and/or selling rights and title to the world's fresh waters.

The present invention solves these heretofore unmet needs.

### SUMMARY OF THE INVENTION

The present invention relates to the production, trading and transport of water.

One embodiment of the present invention is a method of preparing water from an ice source, the method comprising:

(a) selecting a water source comprising water in the form of ice, wherein the water has at least one desirable characteristic;

(b) conducting water from the ice source through a plurality of filtration stages, wherein at least one of the plurality of filtration stages comprises clay;

(c) identifying at least three characteristics in the water.

In one embodiment, the ice comprises at least 1000 cubic meters (m³). In various embodiments, the ice is selected from the group consisting of an ice cap, a glacier, and an iceberg. In one embodiment, the desirable characteristic is that the ice is substantially free of at least one material selected from the group consisting of nitrate, nitrite, mercury, lead, arsenic, cadmium, benzene, chlorine, chromium, tetrachloroethylene, trichloroethylene, uranium, 2,4-Dichlorophenoxyacetic Acid (2,4-D), dichlorobenzene, polychlorinated biphenyls (PCBs), trihalomethanes (THMs), volatile organic compounds (VOCs), lanthanoids, actinides, and pesticides. In yet another embodiment, the ice is substantially free of at least three such materials. In various embodiments of the present invention, the characteristics in the water are selected from the group consisting of: geographic location, geological period, quality, source, purity, geological formation, treatment regimen, latitudinal characteristics, mineral content, extraterritorial content, and extraterrestrial content. In a particular embodiment, the water from the ice source comprises a quantity of glycine.

In one embodiment, the one or more filters comprise a permeability value between approximately 10⁻¹⁰ cm/s and approximately 10⁻³ cm/s. In one embodiment, the water has at least one characteristic similar to at least one characteristic of water derived from a sub-polar ice field located approximately between 15 and 60 degrees south latitude. In various embodiments, the characteristics include at least one of the characteristics selected from the group consisting of: purity, mineral content, pH, and acidity. In one embodiment, the source is evaluated to: identify that the source has a total volume of at least 10,000 cubic meters. In a further embodiment, the source is evaluated to determine the presence of glycine in at least a portion of the source. In a particular embodiment, the water is directed through a filter comprising clay. Such a step is referred to as a filtration stage. In a further embodiment, the water is filtered using primarily gravitational energy. In one embodiment, the water is filtered using only gravitational energy. In yet another embodiment, the one or more filters consist essentially of clay. In a further embodiment, the water is packaged for distribution.

The present invention also discloses methods of trading water having particular characteristics. Thus, in one embodiment, a method for trading water is provided, the method generally comprising: (a) connecting a first entity desiring to obtain water having at least one specific characteristic with a second entity having possession of a source of water comprising the at least one specific characteristic; (b) conveying from the first entity to the second entity information relating to the quantity and characteristic of the desired water; (c) based on the information conveyed, transferring at least one right to a quantity of water having the desired specific characteristic that the second entity is willing to transfer, from the second entity to the first entity, wherein the second entity receives compensation in an amount related to the quantity of water covered by the transferred at least one right.

Water of the present invention has at least one specific characteristic. In one embodiment, the specific characteristic is selected from the group consisting of pH, acidity, geographic location, geological period, quality, source, purity, geological formation, treatment regimen, latitudinal characteristics, mineral content, and extraterrestrial content. In one embodiment, the water is substantially free of contaminants. In various embodiments, such contaminants are selected from the group consisting of heavy metals, including transition metals, metalloids, lanthanoids, and actinides (e.g. Mercury, Lead, Chromium, etc.), uranium, arsenic, chlorine, cadmium, benzene, chlorine, tetrachloroethylene, trichloroethylene, 2,4-Dichlorophenoxyacetic Acid (2,4-D), dichlorobenzene trihalomethanes (THM's), uranium, PCBs (polychlorinated biphenyls), nitrate, nitrite, pesticides, herbicides, volatile organic compounds (VOCs), carbon emissions from coal and petroleum fired power plants, and harmful microorganisms such as colifoini bacteria, giardia, and cryptosporidium.

In various embodiments, the entities can be individuals or groups of individuals such as corporations, partnerships, agencies, non-profit agencies, and the like, or combinations thereof.

Any means of connection that allows communication between the entities can be used to practice the present invention. In one embodiment, the connection is formed using at least one electronic device. In various embodiments, the at least one electronic devices includes, but is not limited to, a data transmission device, a telephone, a cellular phone, a facsimile machine, and a computer. In one embodiment, the connection is formed through an exchange. In a particular embodiment, the exchange is located within a single structure. In one embodiment, the exchange is connected to more than one individual structure.

According to the present invention, various rights in water of the present invention can be transferred between entities. In one embodiment, the right is an option to obtain title to an amount of water. In one embodiment, the right is the right to use an amount of water as an asset. In yet another embodiment, the right is title to an amount of water. In a further embodiment, the method comprises transferring physical possession of the water to an entity other than the second entity.

One of skill in the art will recognize that storage, as well as transport, of commodities is an important and necessary feature of trading systems. Thus one embodiment of the present invention is a method of delivering non-saltwater to a destination using oil tankers. Such tankers can be oil tankers or liquid natural gas (LNG) tankers. Such embodiments are generally practiced by:

a) providing a tanker with cargo at a first location and having a second location as a destination port for delivery of the cargo, wherein said cargo is delivered at said destination port such that the tanker is emptied, except for residual cargo residue left behind;

b) substantially filling the tanker with non-salt water in both a ballast section of the tanker and in a second section of the tanker that previously held cargo for transport;

c) at least partially treating said non-salt water contained in said tanker while en route to said second destination, said water treatment selected from the group consisting of at least two of the following:
i) treating the water; and
ii) segregating water treated in accordance with step i) from water that has not been treated in accordance with step i).

In one embodiment the tanker is an oil tanker. In another embodiment, the tanker is a LNG tanker. In one embodiment the cargo is oil. In another embodiment, the cargo is natural gas.

In various embodiments, the treatment step comprises at least one method selected from the group consisting of filtration through a natural clay filter, centrifugation, reverse osmosis, gravity separation, contact with a natural coagulant, adjusting pH to between about 6 to about 11, UV irradiation, and ozonation. In one embodiment, the step of segregation is accomplished by at least one of: conveying said water treated in accordance with step i) to a substantially cargo-free storage section of the oil tanker; and conveyance of said water treated in accordance with step i) to a very large bag adapted for containing water. In a further embodiment, the water is further treated upon arrival at the second location.

It is yet another aspect of the present invention to provide means for mooring, stabilizing, and/or parking devices adapted for use with the present invention. For example, U.S. Patent Application Publication No. 2004/0157513 to Dyhrberg, which is hereby incorporated by reference in its entirety, discloses a mooring system for mooring a vessel to a floor portion of a body of water. These and similar devices may be incorporated into various embodiments described herein in order to accommodate, for example, issues related to dock or on-shore storage restrictions, weather and tidal conditions, unpredictable transit times, legal and insurance issues related to positioning a device on-shore or at a dock, and physical restrictions associated with shallow water ports. As used herein, a substantially immovable object refers to mooring devices (despite their general ability to drift or float within a certain radius) as well as more traditional fixed objects such as docks, land, anchored vessels, anchors, etc.

### BRIEF DESCRIPTION OF THE FIGURES

FIG. 1 is a plan view of a natural glacial melt water filtration system, utilizing gravity and additional geologic structural members to provide thorough filtration.

FIG. 2 is a plan view of an embodiment of the present invention using multiple iterations of natural filtration for glacial melt waters.

FIG. 3 is a top view of an embodiment of the present invention where glacial ice or water may be selectively diverted through various filters.

FIG. 4 is a flowchart illustrating one embodiment of the present invention where natural potable water is obtained from glacial ice.

FIG. 5 depicts an exemplary final product in accordance with embodiments of the present invention.

FIG. 6 exemplifies trading of water between two entities.

FIG. 7 exemplifies the use of external markets for determining compensation.

FIG. 8 is a side view of a crude oil tanker.

FIG. 9 is a plan view of a crude oil tanker.

FIG. 10 is a mid cross section of a crude oil tanker.

FIG. 11 is a plan view showing a ballast bag 121, which is shaped to conform with the contours of a ships ballast hold 101.

FIG. 12 illustrates the details of a unit that also has the combustor and the water pipe.

FIG. 13 illustrates the details of a unit that also has the combustor and the water pipe.

FIG. 14 depicts one embodiment of the present invention wherein a tanker 102 is utilized to transport cargo from a country, region, or port 100 rich in such resources to a region having a demand for the same 104.

FIG. 15 is a top plan view of a shipping container 200 with one or more internal storage volumes 202.

FIG. 16 depicts a cross section of ships showing ballast tanks and ballast water cycles.

FIG. 17 illustrates a cross section of a ship provided with a ballast water intake and treatment system related to the presently disclosed embodiments and illustrates how a membrane treatment unit is arranged in the water intake that is conventionally hollow.

FIG. 18 schematically show vessel 10 including stern 12, bow 14 and a double hull formed from outer hull 16 and inner hull 18.

FIGS. 19 and 20 show that conduit 118 delivers ozone treated water to each ballast tank of a starboard battery of tanks 126 and conduit 120 delivers ozone treated water to each ballast tank of a port battery of tanks 128.

FIG. 21 schematically shows detail of bypass injection of ozone into a diverted portion of water loading to or unloading from a ballast tank.

FIG. 22 is a side view of a towing and attachment arrangement for a transporter embodiment.

FIG. 23 depicts various trade routes where oil tankers travel and where water can be delivered via various aspects of the present invention.

FIG. 24 is a perspective view of an oil tanker connected to a very large bag to facilitate transfer of water there-between in certain embodiments of the invention.

FIG. 25 is a perspective view of a barge with water filtration and treatment equipment on board.

### DETAILED DESCRIPTION OF THE INVENTION

The present invention generally relates to systems and methods for producing, trading and distributing water. More specifically, the present invention is based on the realization by the inventors that water having specific characteristics, methods of trading such water, and methods of transporting such water, provide benefits and opportunities not obtainable from present water sources, trading methods or transportation methods. In particular, the present invention provides methods of obtaining water having particular, desirable characteristics, methods of transporting such water, and methods of trading such water in a market-responsive fashion.

At the heart of the present invention is the realization that water is a desirable asset, the value of which is derived mainly from its characteristics, as well as a disparity between where the desirable water is located versus where it is desired or needed. Any characteristic present in water can give it value so long as an entity exists that desires water having that characteristic. Most characteristics relate to the source of the water, how it has been, or has not been, processed, its location, its amount, or combinations thereof. Examples of such characteristics include purity (i.e., the presence of other components such as contaminants, mineral content, etc. in the water), geographical location of the water, as well as the historical time period in which the water was formed.

The value of water containing a particular characteristic, or set of characteristics, is completely dependent on the willingness of entity to exchange something of value for water containing such characteristics. Furthermore, such willingness is directly related to that entities need for the water. Because needs will vary, there is no universally optimum water. Instead, entities will seek out water having a characteristic sufficient to satisfy their need, and usually, which requires the lowest level of compensation. Thus, water of the present invention can be any water for which an entity is willing to exchange something of value in order to satisfy a need.

One characteristic of water is the source from which it is obtained. As has been discussed, one unique source of water is ice, in particular ice from ice caps and glaciers. Because of the process by which ice caps and glaciers form, and because of their age, water stored in ice caps and glaciers was frozen in place so long ago that it has unique properties not present in surface water. Thus, one embodiment of the present invention is a method of preparing water from an ice source, the method comprising:

(a) selecting a water source comprising water in the form of ice, wherein the water has at least one desirable characteristic;

(b) conducting water from the ice source through a plurality of filtration stages, wherein at least one of the plurality of filtration stages comprises clay;

(c) identifying at least three characteristics in the water.

In one embodiment the source of ice comprises at least 1000 cubic meters (m³). In one embodiment the source of ice is selected from the group consisting of an ice cap, a glacier, and an iceberg. In a further embodiment, the ice is substantially free of at least one material selected from the group consisting of nitrate, nitrite, mercury, lead, arsenic, cadmium, benzene, chlorine, copper, chromium, tetrachloroethylene, trichloroethylene, uranium, 2,4-Dichlorophenoxyacetic Acid (2,4-D), dichlorobenzene, polychlorinated biphenyls (PCBs), trihalomethanes (THMs) and volatile organic compounds (VOCs). In one embodiment, the ice is substantially free of at least three such materials.

In one embodiment, the characteristics are those desirable to a consumer. In one embodiment, such characteristics are selected from the group consisting of: geographic location, geological period, quality, source, purity, geological formation, treatment regimen, latitudinal characteristics, mineral content, extraterritorial content, and extraterrestrial content.

In a further embodiment, the method comprises verifying that the water from the ice source comprises a quantity of glycine.

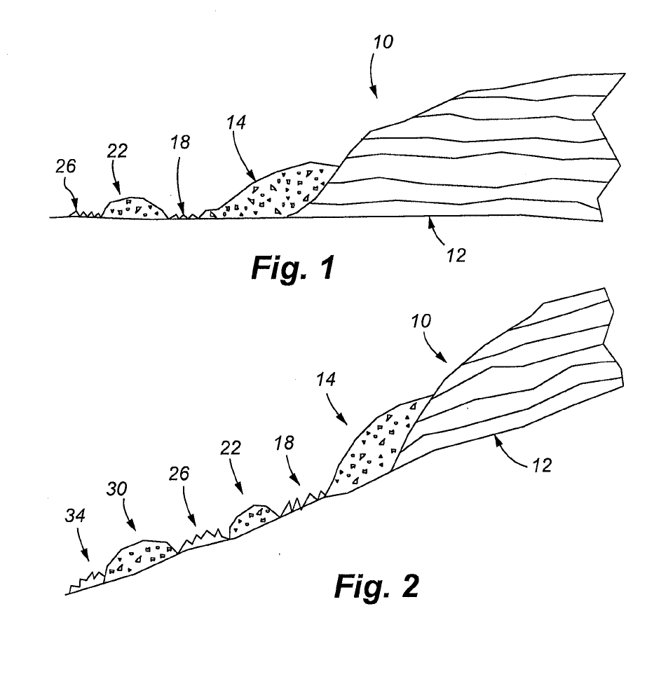

With further regard to water obtained from ice, one embodiment of the present invention is exemplified with reference to FIGS. 1-5.

FIG. 1 is a plan view of glacial ice and melt water 12 as it is subjected to colloidal clay filtering. One aspect of the present invention is that the source water 10 is of a high degree of purity at the beginning of the process. With respect to the present invention, a high degree of purity refers to an ice or water source that is substantially free of harmful contaminants While it will be recognized that certain contaminants may be more or less harmful to different individuals, substantially free of harmful contaminants with the respect to the present invention means that the source contains such a low level of contaminants as to not cause illness or harm to an adult human when up to 128 fluid ounces are consumed on a daily basis. By selecting a water source of sufficient initial purity, natural and organic filtering can be applied to produce high quality potable water without the use of sterilization chemicals or energy intensive filtration means.

It is known that soil acts as a natural filter of water. In addition to the mechanical capturing of solid particles, the term filtering in this context also involves retaining chemicals, transforming chemicals, and restricting the movement of certain substances. These acts of filtering are often known as soil attenuation. Soil attenuation includes the ability to immobilize metals and remove bacteria that may be carried into the water through such means as human or mammalian waste. It is further known that fine textured soils, such as clay, provide superior filtration of water when compared to large grained or coarse soils such as sand. Water travels through coarse soils more rapidly, thereby reducing contact between the water and soil and thus reducing filtration or attenuation. Permeability is a typical measure of a soil's ability to transmit water and other fluids. Clay is known to have a relatively low permeability as a result of its small grain size and large surface area, causing increased friction between water transmitting through the clay. Clay may have a permeability, or hydraulic conductivity, as low as 10⁻¹⁰ centimeters per second whereas well sorted sands and gravels typically have a permeability of 10⁻³ to 1 centimeter per second.

The method depicted in FIG. 1 depicts the natural process by which glacial water 18, 26 is filtered through clay deposits 14 under the force of gravity and is further subjected to additional filtering 22 through clay of the same composition that is selectively positioned by the operator of the current invention. In one embodiment of the present invention, the soil used in filtration is of permeability between 1 and 10⁻¹² centimeters per second. In a preferred embodiment, soil used in the filtration has permeability approximately between 10⁻⁵ and 10⁻¹¹ centimeters per second. In a more preferred embodiment, soil is used in the filtration process that has permeability approximately between 10⁻⁸ and 10⁻¹⁰ centimeters per second. Other methods of quantifying permeability, such as the Darcy unit or SI units (e.g., henry per metre: H/m=m kg/s² A²), can also be used. Such methods are known to those skilled in the art. This additional phase of clay filtration 22 is selectively implemented by the user to create an additional filtration process in an area with sufficient flow rate.

It will be recognized that this additional clay filter need not be of any particular size. Creation of the appropriate sized filter will largely be determined by the user's needs and the natural flow rate of melt water in the particular setting. By taking advantage of the gravitational potential energy of glaciers, ice caps, and the like, the present invention offers a significant advantage over traditional household and commercial filtration processes, such as reverse osmosis, in that the current process does not require energy input generated from hydrocarbon sources. While it will be recognized that initial construction of additional clay filtration stages 22 may potentially require energy input from hydrocarbon fuels, renewable energy sources including human power, or other input, it is an object of the present invention that these filtration stages will operate under the energy provided by gravitational potential energy and the kinetic energy of ice and water.

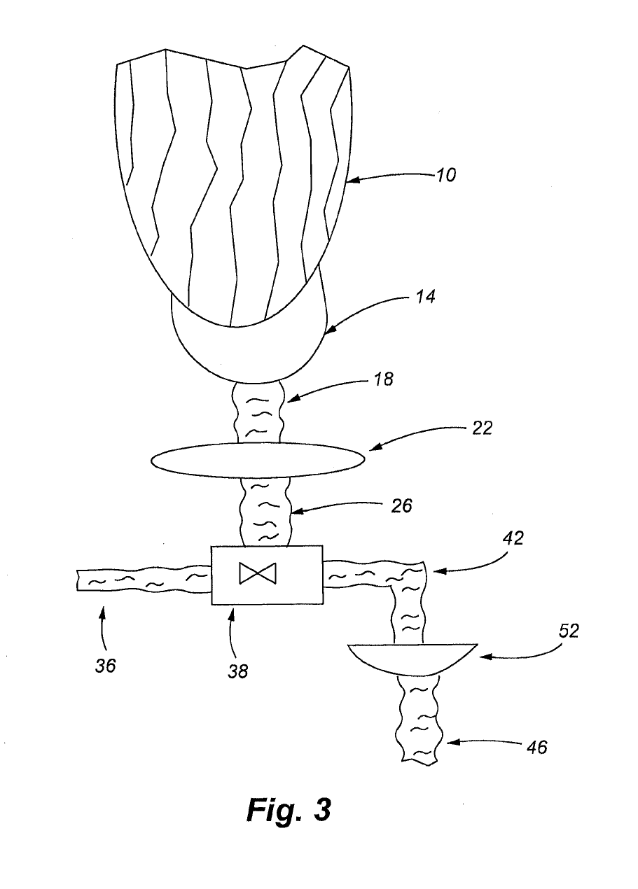

FIG. 2 depicts an embodiment of the present invention where a plurality of additional clay filters 22, 30 have been constructed to further filter and purify glacial water. It will be known to one of skill in the art that any number of additional filtration phases may be constructed. Accordingly, the present invention may be accomplished as described herein with any feasible number of filters.

FIG. 3 depicts another embodiment of the present invention where the source ice or water 10 is filtered through natural clay 14, further filtered through a constructed additional clay filter 22, and selectively diverted by a diversion device 38 (such as, for example, a valve, tap, switch or gate) based on whether or not additional filtration is desired. The diversion device 38 may be selectively adjusted to divert water and ice 36 that the user does not desire to undergo additional filtration to bottling or processing facilities. Alternatively, the diversion device 38 may also be selectively positioned so that water and ice 26 are subjected to further constructed filter iterations 32. The resulting water and ice 46 may then be diverted to processing and bottling facilities, subjected to further filtrations, or subjected to additional control valve and filtration steps as previously described.

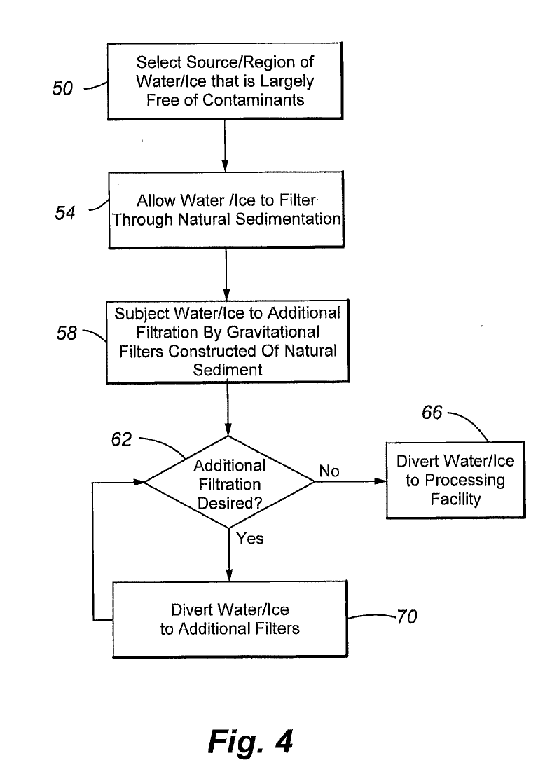

FIG. 4 depicts a flowchart describing one embodiment the present invention. The initial step 50 involves selecting an ice source, such as a glacial body or ice cap, of sufficient purity. While it will be recognized that many natural sources of water and ice contain some level of impurity, one embodiment of the present invention contemplates a source that is generally untouched by human and/or mammalian beings and located in latitudes where emissions from industrialized nations have very little impact. While the present invention is not limited to application in any particular region, glacial ice and ice caps south of 15 degrees latitude are well suited for this process. Once a water source is identified, the present invention contemplates allowing the glacial ice and melt water to channel naturally through sediment in its surroundings 54. Ideally, this sediment is composed of clay or similar soil which provides a low permeability and naturally filters the water. After this first step of filtration has occurred, the resulting water is then passed through additional man-made sedimentary filters 58. In this regard, man-made can refer to filters comprising natural materials, but which have been constructed to further filter the water. In one embodiment of the present invention, these filters comprise the same or similar clay-like soil as in process 54. The water may either be selectively diverted to the additional man-made filters, or the filters may be constructed in the natural path of the water. It is a critical feature of the present invention that this sedimentary filtration 54, 58 is powered solely by gravitational forces. One benefit that will be recognized is the reduced or eliminated need to provide energy input to achieve filtration. Decision block 62 involves a determination of whether the water and ice should be subjected to additional sedimentary filters or diverted to a facility for processing and/or bottling. If additional filtration is not desired, the water may be diverted by, for example, diversion device 38 to the processing or bottling facility 66. One of ordinary skill in the art will realize that this diversion device may be comprised of a gate valve, ball valve, globe valve, three-way valve, or any valve suitable for diverting water or ice. If additional filtration is desired, the valve may be selectively positioned to divert the water or ice to additional sedimentary filters of the previously discussed composition 70.

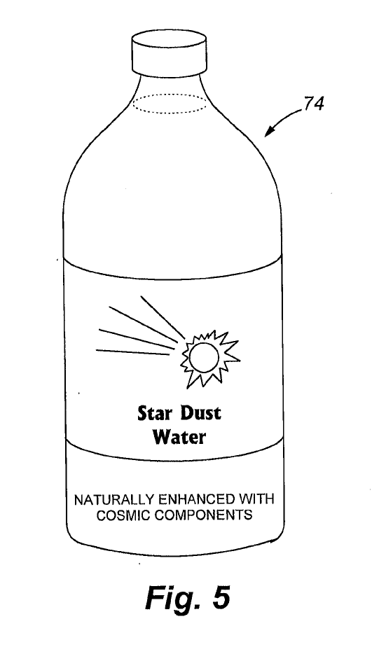

FIG. 5 depicts an exemplary final product 74 of the present invention whereby clean, filtered, potable water is produced without the use of sterilizing chemicals, such as chlorine or iodine, or energy intensive filtration processes. A benefit of the present invention is the ability to produce pure, potable water without destroying, filtering, or eliminating desirable active contents. By filtering the source water by natural sedimentary processes, it is possible to market a product that may contain amino acids, such as glycine and other amino acids traceable to extraterrestrial bodies. With respect to the present invention, extraterrestrial bodies refer to comets, meteors, and other similar bodies. The prospect of producing pure, healthy water with prospect of drinking the original building blocks of life on Earth holds significant commercial appeal.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present invention. The embodiments described above are further intended to explain the best mode presently known of practicing the invention and to enable others skilled in the art to utilize the invention in other embodiments and with various modifications required by their particular application or use of the invention. It is intended that the appended claims be construed to include alternative embodiments to the extent permitted by the prior art. It will be recognized that the steps described herein may be conducted in a variety of sequences without violating the novelty or spirit of the present invention. In one particular embodiment, the present invention is conducted by adhering to a sequence of first selecting a water source substantially free of harmful contaminants, subsequently constructing one or more filters at a point of lower gravitational potential energy than the source, subsequently identifying signature characteristics of the filtered water, and finally packaging the water for distribution.

Another characteristic that affects the value of water is the relative purity of the water. In this regard, purity refers to the presence of molecules, other than water molecules, in the water. Water that contains nothing but water molecules would be considered 100% pure water. Any molecule present in the water, other than a water molecule, reduces the purity of the water. Purity can be measured using techniques known in the art including, but not limited to, refractive index, color, turbidity, conductivity and pH. Moreover, purity can be reported in units such as, for example, percent on a volume per volume or weight per volume basis (e.g., less than 0.01% contamination, less than 0.5% contamination, less than 1% contamination, less than 5% contamination, less than 10% contamination, etc.), concentration (e.g., 1 mg/ml, 5 mg/ml, 10 mg/ml, etc.), parts per million (e.g., less than 0.0001 ppm, less than 0.0005 ppm, less than 0.001 ppm, less than 0.005 ppm, less than 0.01 ppm, less than 0.05 ppm, less than 0.1 ppm, less than 0.5 ppm, less than 1 ppm, less than 5 ppm, less than 10 ppm, etc.), electrical resistivity (e.g., at least 0.01 meagohm, at least 0.02 megaohms, at least 0.05 megaohms, at least 0.1 megaohms, at least 0.5 megaohms, at least 1 megaohm, at least 5 megaohms, at least 10 megaohms, at least 15 megaohms etc.), or electrical conductivity (e.g., less than 100 micro Siemens/cm [μS/cm], less than 50 μS/cm, less than 25 μS/cm, less than 10 μS/cm, less than 5 μS/cm, less than 1 μS/cm, less than 0.5 μS/cm, less than 0.1 μS/cm, less than 0.05 μS/cm, less than 0.01 μS/cm). Methods of determining and adequately reporting purity are known to those skilled in the art.

From the above discussion, it will be appreciated that different grades of water exist, the grade being based on the amount of contaminants present in the water. A relative grading scale can be envisioned in which water having the highest purity is on one end, or top, of the scale, and water having the lowest purity being on the opposite end, or bottom, of the scale. Such a grading scale is useful for characterizing water having different levels of non-water molecule (i.e., contaminant or pollutant) content.

Water of all grades has a use, and the purity, or grade, of water desired will affect on the use for which the water is intended. For example, the manufacture of semiconductors requires ultrapure water (UPW). While no exact definition exists for UPW, such water is viewed as the “cleanest” water on the planet. That is, UPW water is viewed as being as close to 100% pure water as currently possible.

As a further example, drinking water would be found further down on the grading scale. While water for drinking may be casually referred to as pure, it almost always contains other compounds such as, for example, minerals. However, since such minerals are not harmful, and in fact may be beneficial, in the amounts being consumed, such water is considered adequate for drinking.

In another example, sewage water, which contains waste from toilets, showers, etc., along with fluid from industrial waste, and thus contains numerous and copious amounts of contaminants, would be even further down on the scale. The grade of a water may have no relation to the value of that water since, as noted above, the value of the water is directly related to an entities willingness to exchange something of value for the water, which itself is related to the need for such water. Thus, water of all grades has a use and thus, has some value. For example, when the reactor cores at the Fukushima Daiichi nuclear plant in Japan became exposed, there was a need for large quantities of water with which to cool the overheating cores. Thus, seawater, which was of a grade that would normally be considered of little value, was used to cool the reactor cores. At that point in time, while the grade of the water did not change, its value was raised simply due to an increased need for its characteristics, in particular its ability to cool reactor cores and its abundance. Thus, it is seen that the value of water is directly tied to the need for its characteristics. It is further seen that the value of water is tied to the desire for water having specific characteristics.

Returning to the grading scale, it will be appreciated that numerous types of water, having various grades, exist between the ends of the scale. The grading of water can be based on such things, for example, as the concentration of solid and or liquid contaminant in the water, the danger posed to life by a contaminant in the water, or the ease of removing a contaminant Examples of types of water that can be graded using such a scale include, but are not limited to, seawater, water mixed with oil, water mixed with industrial chemicals, water recovered from fermentation reactions, pond water, lake water, river water, water recovered from cooling equipment (e.g., cooling water from a nuclear reactor), and wastewater. In this context, wastewater refers to water held by an entity that is no longer considered useful for the purposes of that entity. Examples of wastewater include, but are not limited to, wastewater from beverage production facilities, wastewater from food production facilities, wastewater from paper production facilities, wastewater from fiber and/or clothing production facilities, wastewater from leather production facilities, wastewater from a slaughter house, wastewater from chemical production facilities, wastewater from refineries, wastewater from electronic component production facilities, and wastewater from agricultural facilities. It will be appreciated that while such water is referred to as wastewater, such water may be useful for uses other than the original use of the “cleaner” water. For example, wastewater from fermentation reactions may be useful to an entity looking for a cheap source of fertilizer.

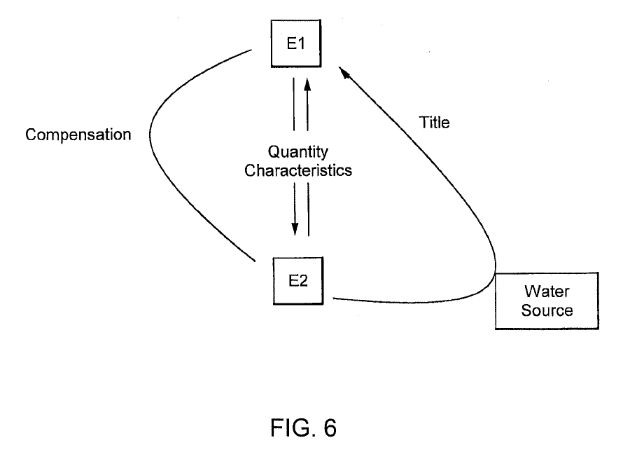

Because water of the present invention has desirable characteristics, it has value to entities desiring such water and therefore represents an asset capable of being traded. Thus, a key feature of the present invention is a method for trading water of the present invention. In this regard, one embodiment of the present invention is illustrated in FIG. 6. The illustrated embodiment is a method generally practiced by:

(a) connecting a first entity (E1) desiring to obtain water having at least one desirable characteristic with a second entity (E2) having possession of a source of water comprising the at least one desirable characteristic;

(b) conveying from the first entity to the second entity information relating to the quantity and characteristic of the desired water;

(c) based on the information conveyed, transferring title to a quantity of water having the desired specific characteristic that the second entity is willing to transfer, from the second entity to the first entity, wherein the second entity receives compensation in an amount related to the quantity of water covered by the transferred title.

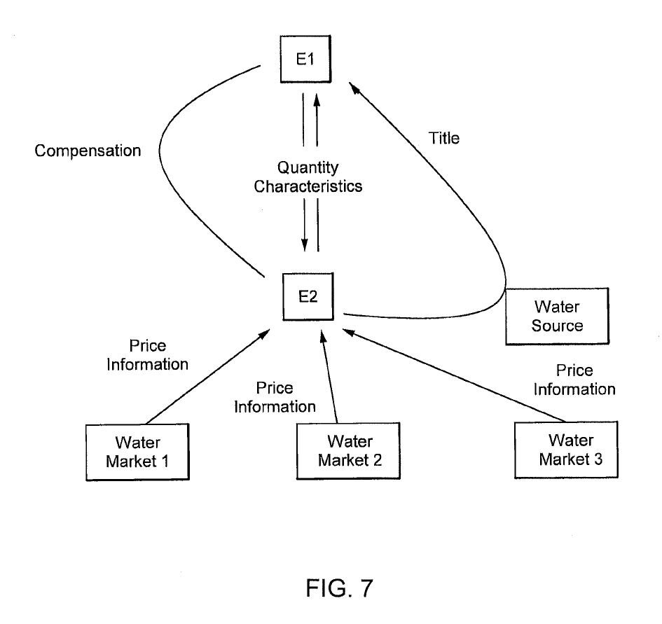

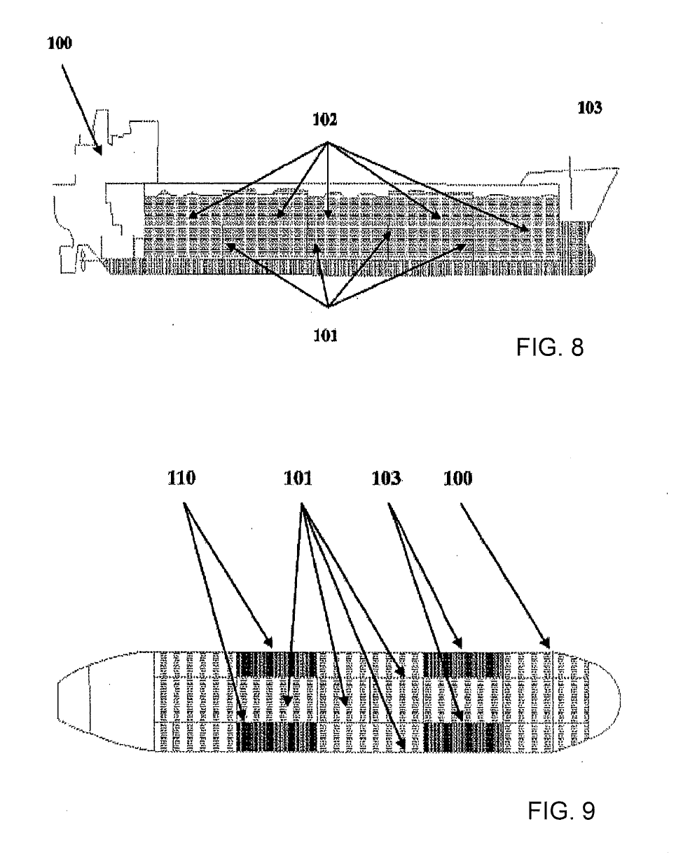

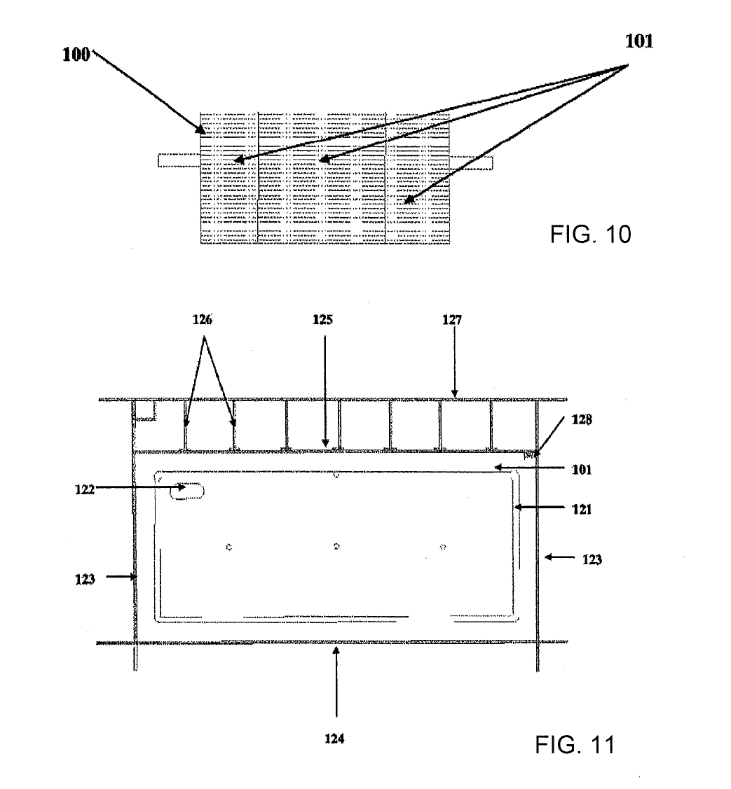

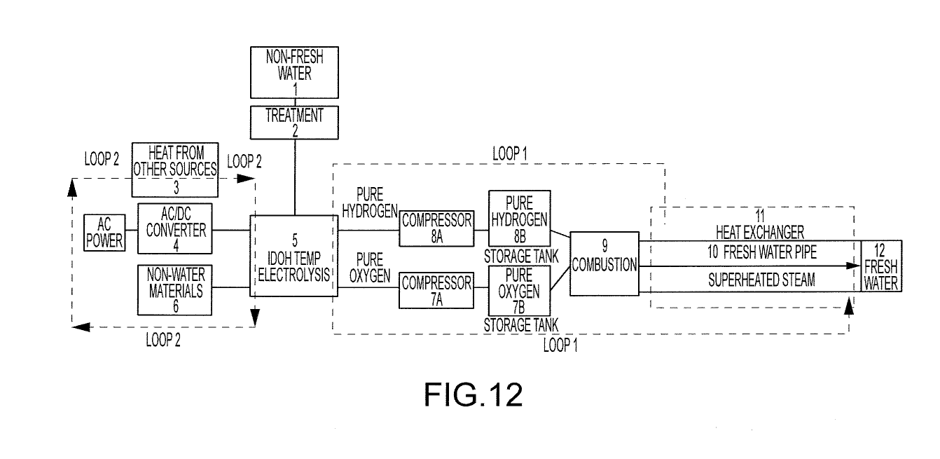

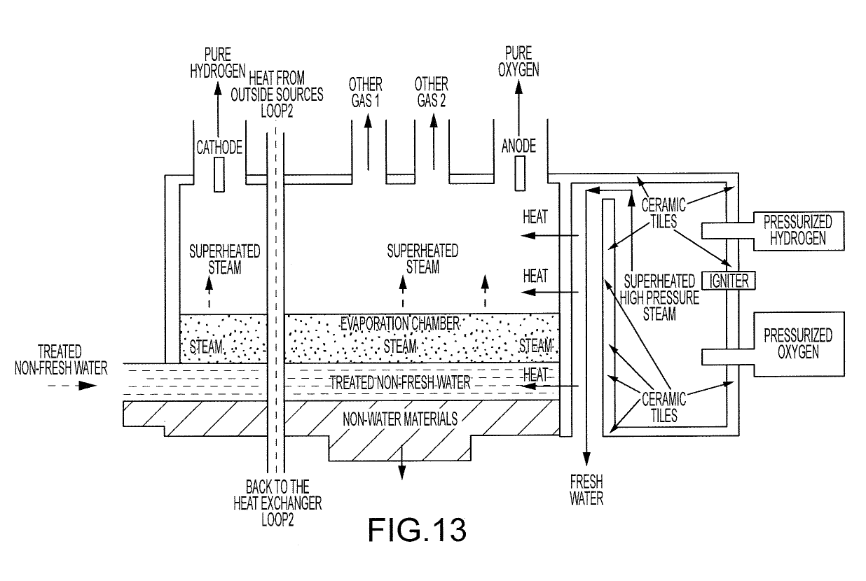

In one embodiment, a method of the present invention is practiced according to FIG. 7. That is, the method comprises:

(a) connecting a first entity (E1) desiring to obtain water having at least one desirable characteristic with a second entity (E2) having possession of a source of water comprising the at least one desirable characteristic;

(b) conveying from the first entity to the second entity information relating to the quantity and desirable characteristic of the water;

(c) based on the information conveyed, granting an option to take title to a quantity of water having the desired specific characteristic, by the second entity to the first entity, wherein the granting of the option comprises an agreement by both entities that the second entity will receive compensation in an amount related to the quantity of water covered by option.

According to the present invention, the entities involved in the claimed methods can be individuals or groups of individuals such as, for example, corporations, partnerships, agencies, non-profit agencies, and the like, or combinations thereof. Moreover it should be noted that the composition of one entity of the claimed method is independent of the composition of the other entity. That is, for example, the first entity may be an individual while the second entity may be a company. Any such combination is contemplated. Moreover, the role performed by the two entities of the claimed method may be conducted by the same individual or group of individuals, as such an arrangement offers certain advantages. By way of example and in further support of the present disclosure, U.S. Patent Application Publication No. 2010/0063902 to Constantz et al. is incorporated herein by reference in its entirety.

In one embodiment, a method of trading and transporting water is provided, the method generally comprising a trading platform for identifying areas of high water supply and/or low value supply. In various embodiments, the platform, which may take the form of an electronic database, identifies areas of low water supplies and/or areas where water would be considered “high value.” For example, in various embodiments, a method and system of the present invention may comprise a platform for determining areas or entities having large quantities of water available for shipment

Water trading platforms, such as those available through Waterfind Water Market Specialists of Australia, are generally known for bringing potential buyers and sellers of water and/or water rights together. Various features, systems, and methods of the present invention further contemplate connecting individuals and entities across great distances and transporting or conveying water across such distances. Accordingly, various features, systems, and methods of the present invention provide worldwide liquidity to any number of water markets. In various embodiments, water trading is expanded beyond simple irrigation districts, watersheds, counties, and even countries. The present invention contemplates a global water market wherein buyers and sellers are connected regardless of spatial relationships. Thus, for example, whereas relatively small regions having disparate climates and water supplies/needs may benefit from traditional water rights trading systems (e.g. where water may be diverted through local infrastructure), the present invention contemplates connecting individuals, entities, and states whether they be separated by a matter of feet or a few thousand miles.

As used herein, the terms connecting, connect, linking, link, and the like mean that the two entities interact in within a system in such a way as to allow a two-way transfer of information. The system can be any means of connection that allows a communication between the entities. In one embodiment, the connection is formed using an electronic device. Any electronic device is suitable so long as it allows communication between the entities. Examples of useful electronic devices include, but are not limited to, data transmission devices, telephones, cellular phones, facsimile machines, computers, and the like.

In one embodiment of the present invention, the two entities connect through an exchange. As used herein, an exchange is a system where assets such as, for example, stocks, bonds, options, futures, commodities, and the like, are traded. Entities having or desiring assets connect in the exchange to trade ownership in the assets for compensation. In one embodiment of the present invention, an exchange is envisioned as trading water, options, ownership rights therein, and the like, although the trade of other stocks, bonds, options and futures, commodities and the like, may also occur within the same exchange. Such an exchange can be located at one or more physical locations that may or may not be connected by means of communication, such as, for example, telephone or data transmission lines. In one embodiment, the exchange lacks a physical location, such as a building devoted exclusively to the exchange, and exists solely on a data transmission network such as a computer network. It should also be understood that an exchange may refer to an existing exchange (e.g., The New York Stock Exchange, The Chicago Mercantile Exchange, etc.), or it may refer to an entirely new exchange.

With regard to the present invention, water refers to water having one or more characteristic that renders it desirable to a consuming population. In one embodiment, the characteristic possessed by the water has high degree of purity. A high degree of purity refers to water that is substantially free of harmful contaminants. A contaminant is any substance in the water deemed undesirable by the purchaser of the water. Examples of contaminants include, but are not limited to, for example, heavy metals, including transition metals, metalloids, lanthanoids, and actinides (e.g. Mercury, Lead, Chromium, etc.), uranium, arsenic, chlorine, trihalomethanes (THM's), uranium, PCBs (polychlorinated biphenyls), nitrate, nitrite, pesticides, herbicides, volatile organic compounds, carbon emissions from coal and petroleum fired power plants, and microorganisms such as, for example, coliform bacteria, giardia, and cryptosporidium. While it will be recognized that certain contaminants may be more or less harmful to different individuals, substantially free of harmful contaminants means that the source contains such a low level of contaminants as to not cause illness or harm to an adult human when up to 128 fluid ounces are consumed on a daily basis. Methods of determining and quantifying purity are known in the art and have been discussed herein.

In one embodiment of the present invention, the high level of purity is the result of natural processes such as, for example, filtration through soil. By selecting a water source of sufficient initial purity, natural and organic filtering can be applied to produce high quality potable water without the use of sterilization chemicals or energy intensive filtration means.

As has been discussed, FIG. 1 depicts the natural process by which glacial water [18, 26] is filtered through clay deposits [14] under the force of gravity and is further subjected to additional filtering [22] through clay of the same composition that may or may not be selectively positioned by the operator of the current invention. In one embodiment of the present invention, the soil used in filtration is of permeability between 1 and 10⁻¹² centimeters per second. In a preferred embodiment, soil used in the filtration has permeability approximately between 10⁻⁵ and 10⁻¹¹ centimeters per second. In a more preferred embodiment, soil is used in the filtration process that has permeability approximately between 10⁻⁸ and 10⁻¹⁰ centimeters per second. This additional phase of clay filtration [22] can be selectively implemented by the user to create an additional filtration process in an area with sufficient flow rate.

It will be recognized that this additional clay filter need not be of any particular size. Creation of the appropriate sized filter will largely be determined by the user's needs and the natural flow rate of melt water in the particular setting. By taking advantage of the gravitational potential energy of glaciers, ice caps, and the like, the present invention offers a significant advantage over traditional household and commercial filtration processes, such as reverse osmosis, in that the current process does not require energy input generated from hydrocarbon sources. While it will be recognized that initial construction of additional clay filtration stages [22] may potentially require energy input from hydrocarbon fuels, renewable energy sources including human power, or other input, it is an object of the present invention that these filtration stages will operate under the energy provided by gravitational potential energy and the kinetic energy of ice and water.

FIG. 2 depicts an embodiment of the present invention where a plurality of additional clay filters [22, 30] have been constructed to further filter and purify glacial water. It will be known to one of skill in the art that any number of additional filtration phases may be constructed. Accordingly, the present invention may be accomplished as described herein with any feasible number of filters.

FIG. 3 depicts another embodiment of the present invention where the source ice or water [10] is filtered through natural clay [14], further filtered through a constructed additional clay filter [22], and selectively diverted by a control valve [38] based on whether or not additional filtration is desired. The control valve [38] may be selectively adjusted to divert water and ice [36] that the user does not desire to undergo additional filtration to bottling or processing facilities. Alternatively, the control valve [38] may also be selectively positioned so that water and ice [26] are subjected to further constructed filter iterations [32]. The resulting water and ice [46] may then be diverted to processing and bottling facilities, subjected to further filtrations, or subjected to additional control valve and filtration steps as previously described.

In one embodiment, the characteristic possessed by the water is that it is from a specified time period. The ability to trade water from previously frozen ice that is over hundreds, if not thousands, if not millions of years old, by its nature constitutes a new process and product. Furthermore the ability to date these layers of frozen ice and generally correspond it to a given time era is advantageous in that different properties of water corresponding to different layers may exist. Such properties can be used as the basis for satisfying different consumer markets. While it is acknowledged that ice has been melted to derive water in the past, it has not been accomplished under conditions that preserve the pristine aspects of such water and categorize those aspects according to their date. While the present invention is not limited to any particular region, ice caps and glacial ice south of 15 degrees latitude are well suited for the claimed method.

In accordance with embodiments of the present invention, the ice from a glacier and/or ice sheet can be cut, drilled, and/or divided into various segments. The cutting, drilling, and/or division of the segments can separate the ice into either vertically or horizontally separated segments. The segments can then be further divided by date into other segments. These dated segments are then processed under strict hygienic conditions such that the properties of the water are maintained and not polluted. In a preferred embodiment, the processing of the ice is performed under an increased atmospheric pressure and where staff must be present during the operations. The staff should wear special clothing adapted to the purpose of maintaining the hygienic properties of the water. Preferably the cutting, drilling, and/or tapping and subsequent packaging of the ice are performed in accordance with FDA current good manufacturing practice for processing and bottling of bottled drinking water, 21 CFR 129.

The ice can be drilled from the top or may be extracted from the terminus of the glacier such that the layers are taken out directly without an intermediate step as required by the vertical recovery of the ice. Furthermore, various layers of the ice can be tapped and pumped in an effort to recover the water contained therein. It is one aspect of the present invention to provide a method of processing ice from a glacier or ice sheet. The ice is extracted from the reservoir, i.e., glacier or ice sheet. The ice is then segmented and categorized by date. Thereafter, each segmented section of ice is processed separately under hygienic conditions such that the pristine aspects of the water are maintained. The water is then packaged separately and labeled according to the date from which the ice existed. For example, renaissance water that came from the early 1400 AD era is bottled separate from water that existed at the time of Christ or around 0 BC. The water may be portioned into any desired amounts (e.g., consumable units, bulk quantities, etc.). Consumable units are generally portion sizes acquired by an individual consumer. In one embodiment, the water is portioned into about one-half liter to one liter volumes, due to the categorization of the ice and subsequent processing of the ice into water comprising different properties from one batch to the next. Such water can then be traded based on the uniqueness of its properties. The inventive process merits a higher selling price of water than simply cutting up ice from a glacier and melting it. Consumers may be willing to pay a premium for water that traces its roots back to the same time that Leonardo da Vinci lived, for example. Therefore, reasonable sizing of the sellable units would be desired based on the attractiveness of the process provided by the present invention.

Alternatively, water from a particular era or containing certain properties could be sold in bulk quantities. Particularly, breweries or distilleries that have a long historic tradition could purchase large batches of dated water. They could then use water that dates back to their original product in order to recreate the original beverage that they used to produce. Many breweries and the like pride themselves on not changing certain recipes over the course of many years. Some breweries and distilleries have been creating the same product for over a hundred years. These companies would be able to purchase water that existed during the days of their founders and could create, market, and sell the “original” product to consumers with literally no changes from the true original. Consumers would be willing to pay a premium for a truly original pint of Guinness® or a bottle of Lagavulin scotch made from water dating back to 1816. Moreover, wastewater generated in the production of the final product, could be traded in an exchange with an entity looking for such water.

Another aspect of the present invention provides a system for categorizing, extracting, processing and packaging water into different historically categorized groups. In accordance with one embodiment, a recovery station is set on or near an ice source (e.g., glacier, ice sheet, ice cap, and the like). Also included is a recovery member that is operable to transmit ice from the ice source to the recovery station. In the recovery station, the ice can then be separated and categorized according to date and processed according to the methods described above.

A further aspect of the present invention provides a method for producing packaged water from glacial ice having a predetermined age. The method includes analyzing the age of a number of layers of glacial ice within an ice source. Then a first layer, whose age is known, is extracted in either a solid or liquid state. The first layer is extracted such that other layers remain substantially undisturbed. This allows the first layer to be substantially separated from the other layers of glacial ice, thereby isolating the characteristics of the water within the first layer. After the water has been extracted it is collected and directed into a container (e.g., a bottle, bag, or the like.) Once the water from the first layer has been effectively packaged, an indication in the form of a tag or label is place on or around the container to reflect the characteristics of the water that is within the container.

Still a further aspect of the present invention provides for a way of recovering and preparing dated water in an economically viable fashion. In one embodiment, a number of containers are separated and filled with water (either from the ice source itself or from another source) in a frozen or liquid state. Water from various segments of the ice source are then extracted from the ice source and then placed into different containers. Essentially, a majority of the water in each container does not need to be extracted according to the costly process described herein. However, a non-trivial amount of categorized water is also in each container such that consumers can be assured that the water they are drinking is at least partially derived from a particular time period and thus has the unique characteristics of water from that time period. The primary water that is used (i.e., the non-categorized water) should be held to the highest purity standards so that when the categorized water is added, the unique characteristics of that water are not lost or disrupted.

In one embodiment of the present invention, the characteristic possessed by the water is the presence of extraterrestrial-derived components. Such components include, but are not limited to, molecules such as amino acids and other organic molecule, that are derived from comets, asteroids, and the like. One example of such a component is glycine, a basic component of proteins. While the details of the potential health benefits of such components have yet to be evaluated, there exists a viable market for unadulterated drinking water which could reasonably be calculated to contain glycine and primordial building blocks of life. In addition to the commercially appealing aspects of consuming the origins of life itself, glycine is known to produce a sweet taste for humans.

In one embodiment of the present invention, the water is sequestered in a form suitable for long teem storage that does not affect the unique characteristics of the water. In one embodiment, the water is sequestered as ice. In a particular embodiment, the water is sequestered as glacial ice. In yet another embodiment, the water is sequestered in a polar ice cap. Various combinations of such sequestration means are also included in the present invention.

In one aspect of the present invention, information regarding, at least, the desired quantity and characteristic of the water being traded, is conveyed between the two entities. Such conveyance refers to the transfer of information using means disclosed herein. The conveyance of such information can also be referred to, for example, as an order or a purchase order. Such orders will contain, at least, the quantity of water desired by the buyer, or the characteristic desired by the buyer. With regard to quantity, also referred to as a tradable unit, the water can be portioned into any suitable volume. For example, the water may be portioned into the previously mentioned consumable units, or it may be traded in bulk quantities. Examples of useful tradable units included, but are not limited to, about 1 liter units, about 5 liter units, about 10 liter units, about 50 liter units, about 100 liter units, about 500 liter units, about 1000 liter units, about 5000 liter units, about 10,000 liter units, about 50,000 liter units, about 100,000 liter units, 500,000 liter units or 1,000,000 liter units. Larger volumes are also envisioned. It should also be appreciated that tradable units can be in volumes using other systems of measurement. For example, such volumes can be measured in pints, quarts, gallons, liters, cubic meters, tons, metric tons, ferkins, kilderkins, barrels, Appropriate measures of volume are known to those skilled in the art.

Orders can also contain information about the characteristic of the water desired by the buyer. Such characteristics have been disclosed herein. However, it should be appreciated that the water being traded can have more than one of the disclosed characteristics. Furthermore, in addition to the characteristics disclosed herein, the water can have other characteristics not mentioned herein. It will be understood by those in the field that orders can contain information relating to topics other than quantity and characteristics of the water being traded. For example, an order may contain information relating to the date of transfer of title of the water, the date of transfer of physical possession of the water, the location of shipment, compensation to be received by the second entity, etc.

It should also be understood that conveyance of information between the two entities may involve back and forth information exchange before the entities reach an agreement on the details of the trade (e.g., quantity and/or characteristic of the water being traded). Such back and forth information exchange may be needed simply for clarification of terms, conditions, and the like, or it may involve haggling, negotiating, discussion, and the like.

Once the entities have agreed on the specifics of the trade (e.g., quantity, characteristics, etc.), if the trade involves immediate transfer of the title, title to a volume of water having the characteristics recited in the order is transferred to the buyer. Such transfer can involve physical recordation, electronic recordation and/or transfer of title documents. Title is used under its commonly understood legal meaning, as are ownership and possession. That is, title refers to the sum total of legally recognized rights to the possession and ownership of property (e.g., water) that can be secured and enjoyed under the law. It should be understood that title can, but does not necessarily imply, rights in ownership or possession. The determination of such rights can be part of the information exchanged between the entities.

Once title has been transferred, the buyer may or may not take physical possession of the water. Physical transfer of the water can occur immediately, at a later time, or it may never occur. It is one aspect of the present invention that transfer of the title to the buyer does not necessarily indicate the buyer is the final consumer. Instead, title in the water can give the buyer the right to further transfer the title to another entity. In this aspect, transfer of the title to the buyer can be viewed as an option to take possession of the water.

As has been discussed, instead of transfer of title, a trade may involve grant of an option to purchase water at some future date. Such arrangements offer some advantages. For example, an entity may have an interest in obtaining water in the future in anticipation of a need. However, in the event the need does not materialize, the entity may allow the option to lapse, and thus save the expense of water that is no longer needed. In another example, the entity desiring to obtain water in the anticipation of a future need may get a better price than the price that exists at the time the need actually materializes. The grant of options may or may not included exchange of currency, or some other object of value, from the grantee to the grantor at the time of grant. The grant of options may also included permission for the grantee to further trade the options with an additional entity. Other such permutations of a trade are known to those skilled in the art. Details of the trade with regard to ownership, timing of the options, timing of any resulting purchases, transfer of the water, and the like, will be negotiated by the first and second entities as part of the back and forth information exchange of the trade.

As previously described, prior to trading, the water can be sequestered, for example as ice. This aspect of the present invention is very beneficial in that the water can be kept sequestered until such time as the buyer, or other party to whom title has been transferred, requests possession of the water. Thus, if the buyer takes title but decides to delay possession, the water can remain sequestered until the buyer, or other party holding title, requests possession. Alternatively, the buyer may request possession upon transfer of title, with the understanding of the practical, physical limitations involved. Nonetheless, once the entity holding title decides to take possession of the water, the seller can then go to the water source, remove the quantity of water being transferred to the title-holding entity, and transfer such volume thereto. In an embodiment where the water is sequestered as ice, the seller can remove sufficient ice, from a region of the glacier or ice cap comprising ice having the agreed upon characteristics, such that, upon melting the volume of water produced is at least the volume being transferred. This melted ice is then transferred to the title-holding entity.

In one embodiment, transfer of title also carries transfer of ownership of the water. Details regarding all rights transferred with the title can be determined during interaction of the buyer and seller.

It is an aspect of the claimed method that the seller receives compensation for transferring the water. Such compensation can be transferred to the seller at any time. In one embodiment, the seller receives the agreed upon compensation prior to transfer of title. In one embodiment, the seller receives the agreed upon compensation simultaneous with transfer of title. In another embodiment, the seller receives the agreed upon compensation after transfer of title. Compensation can be transferred directly from the buyer to the seller, or it can involve additional entities. For example, the seller may transfer title, ownership, and/or possession of water to the buyer, but receive compensation from a third entity not involved with title, possession or ownership of the water (e.g., a bank or parent corporation). Similarly, the amount of compensation can be decided upon between the seller, the buyer, additional entities, or combinations thereof. Further, decisions on the timing of compensation may or may not be part of the order.

Compensation to the seller is an amount agreed upon between the buyer and seller. However, various tools can be used to help determine such an amount. For example, since water in various forms is sold worldwide on a daily basis, a large volume of information exists regarding the price of water. Further, such data can be linked with other characteristics (metadata) (e.g., geographic region) allowing the sorting of the price of water by such characteristics such as, for example, geography, intended use, time or date of purchase, etc. Such data is very useful in determining compensation. Thus, in one embodiment of the present invention, compensation is determined using average price data for water obtained from current water markets. In using such data, the seller obtains the selling price of water from a variety of different markets. Such an embodiment is exemplified in FIG. 7. In a preferred embodiment, the seller uses metadata to obtain the selling price of for water having characteristics related in some meaningful way (e.g., intended use, geographic location of use) to at least one characteristic of the water being transferred.

In some embodiments, the water being traded may be intended for more than one use. For example, some of the water may be used for irrigation while the rest may be used in the production of biofuel. Accordingly, the value of the water may be determined based on such mixed use. To determine such a value, each intended use of the product is given a weight. For example, if 50% of the water were being used for irrigation and 50% being used for the production of biofuel, then the value would be the sum of 0.5× the current average price for water in the biofuel industry and 0.5× the current average price for water in the irrigation market. Example markets from which current average water prices can be determined include, but are not limited to, export markets, domestic markets, desalination markets, drinking water markets, crop production markets, and biofuel production markets. Numerous variations of such markets are envisioned.

With further regard to determining a value for the water being traded, in one embodiment the value is based on a standardized index. According to the present invention, such an index is based on the values of water in various locations as well as virtual water contained in products that contain water or for which water is used in their production. For example, it can be imagined that various water products exist. Examples of such products include, but are not limited to, export markets, domestic markets, desalination markets, drinking water markets, crop production markets, and biofuel production markets. To determine a value relative to the index, various product weights are assigned based on the proportion of the water market represented by that product. For example, if in a given region 20% of the water trade is for biofuel production and 80% of the water trade is purification of water for consumption, the index price is the sum of 0.2× the cost of water for biofuel and 0.8× the cost of water used for consumption. In some embodiments, the index price can be reported as a ratio relative to the price of any particular component. In one embodiment, the index price is reported relative to the index price of water from a different region. Regions envelope geographical areas and the areas included in such a region can be determined by the entity establishing the index. Such an index is described in US20090055294 to Shirazi, which is herein incorporated by reference in its entirety. It will be appreciated that the index of Shirazi is based on the virtual value of water, since Shirazi teaches that the underlying water asset is in reality, inaccessible for use since it is owned by municipalities that are bound to legal restrictions. Shirazi does not teach such an index based on water that is actually available for use. Thus, in one embodiment of the present invention, an index price is created using water, or ice, that is available for uses disclosed herein. In one embodiment, an index price is created using water, or ice, that is now owned by a municipality. In one embodiment, an index price is created using water, or ice, that is privately owned.

By now it will be appreciated that water of the present invention is an asset having a value that can be ascertained. It will be further appreciated that assets can be used as collateral. Thus, one embodiment of the present invention is a method to create a financial instrument based on water. Any water of the present invention can be used. In a preferred embodiment, the water is sequestered as ice. In such an embodiment, the ice is never converted to water and is never moved from its original location. Instead, the water, as ice, is used as collateral to obtain some object of value, such as money, from investors. The object of value is then used for the needs of the entity holding title to the water. Preferably, such needs are used to produce further currency, which is then returned to the investors. In this way, the value of water trapped as ice is realized without the need for obtaining and using the water. Thus, the original source of value (i.e., the water in the ice) is never depleted. In one embodiment, the water is available for uses disclosed herein. In one embodiment, the water is not owned by a municipality. In one embodiment, the water is privately owned.

Heretofore, the valuing of water has been described with regard to current or historical prices. However, such pricing can also be determined based on future value resulting from predicted future events. For example, natural disasters, such as hurricanes, tornadoes, earthquakes, tsunamis, and the like, will result in shortages of fresh drinking water, thereby raising the price that consumers are willing to pay for such water. Further examples of events that may cause water shortages include, but are not limited to, wars, political unrest, mass migrations, religious pilgrimages, and the like. Thus, water prices can also be based on the predicted likelihood of such events occurring. Thus in one embodiment, the price of water is determined based on the likelihood of future events occurring in the world.

With regard to determining the price of water based on predicted storm events, because of storm tracking technology available today, such prediction s can be made with some degree of accuracy. For example, the National Weather Service, which is part of the National Oceanographic and Atmospheric Administration, issues extensive weather-related information, including storm forecasts for targeted regions, at regular intervals. While the prior art discloses using such NOAA information, it should be appreciated that private companies can also be used to obtain such information. In fact, information obtained in this fashion may have more value due to the fact that it is being provided by a politically neutral source. Once such information has been obtained, it can be used to construct maps of storms and maps of predicted storm paths and behaviors. Based on such maps, and the predictive behavior that can be obtained there from, models can be constructed that forecast the need for water in an area. In fact, once weather-related information indicating the formation of a storm has been released, such information can immediately be used to generate a prediction of the number of quantifiable units of water (e.g., gallons, liters, etc.) that will be needed in a particular area. Examples of storm commodity pricing are disclosed in US2010/0042527 to Mitchell and Haynie, which is incorporated herein by reference in its entirety. It should be noted that Mitchell and Haynie exclusively teach the use of storm data. However, as has been described, other world events can also be used to predict the need for water. For example, intelligence data gathered by governments that describes political stability in other countries can be political unrest and possible revolution. The prediction of such events can be used to determine the future need for, and thus the future value or price, for water in those countries.

Moreover, since the presently disclosed methods result in the prediction for the future need for water, such information can also be used to strategically position such water. That is, once it is appreciated that water will be needed at a geographical location due to natural events (e.g., storm), or manmade events (e.g., war), the water can be moved to a location near the site to he predicted event so that it can be distributed in a timely manner. Methods of moving and storing water near such locations will be discussed in more detail below.

In various embodiments, the value of the water can be determined using any of the methods disclosed herein. For example, the value can be based on the value of water intended for use in one or more water markets. As further example, the value of the water can be tied to an index. Moreover, the valuing of water can be determined using any mixture of the methods disclosed herein.

It is an aspect of the present invention that the price, or value, of water can be tied to carbon dioxide and related carbon credits. As described in US2002/0188459 to Erickson, which is incorporated herein by reference in its entirety, the entrance of the carbon dioxide molecules into plants' stomata entails a costly loss of water molecules out of the plants' leaves. For every molecule of carbon dioxide that enters the stomata, between 100 and 400 molecules of water are lost. See Plant Physiology, Salsbury & Ross, page 63. When exposed to elevated carbon dioxide gradients, guard cells in plant leaves relax and close forming a smaller aperture, thus impeding water molecules from escaping through the normally expanded aperture. In a carbon dioxide rich atmosphere, a higher concentration gradient would exist between the exterior and the interior of the leaves, and equivalent amounts of carbon dioxide would diffuse through stomatal openings, even as the stomatal apertures were kept smaller. In most plant species, reduced stomatal openings curtail water loss, so the plants require less water to grow the same size or bigger. The net result is that various crops may use from 20 percent up to 50 percent less water when exposed to elevated levels of carbon dioxide. Thus, it can be envisioned that an inverse relationship exists between the price of carbon dioxide and the price of water. Thus, in one embodiment the price of water is determined taking into account the price of carbon.

Moreover, according to the present invention, the price of the water can be determined relative to the carbon credit trading market. For example, if a given entity practices a process that results in the production of carbon dioxide, that entity needs to dispose of such carbon dioxide. This can be done by releasing it into the environment. However, such release entails the purchase of sufficient carbon credits. Alternatively, the carbon could be sold to a second entity wishing to use it for agricultural production. The price that the second entity would be willing to pay would be directly tied to the advantage given by using such carbon dioxide to fertigate plants. This advantage would have to be compared to the cost of water needed in order to gain the same advantage.

Other related business scenarios are envisioned. For example, the carbon dioxide producing entity may need to pay to get rid of the carbon dioxide. A purchaser could be, for example, an agricultural producer wanting to use the carbon dioxide for fertigation purposes. However, the carbon dioxide producing entity, looking to spend the least amount of capital, would compare the cost of selling the carbon dioxide to the cost of buying carbon credits at the time of disposal. This ratio will vary according to carbon market fluctuations. In such a scenario, it may be cheaper to buy carbon credits, resulting in the agricultural producer needing to purchase more water for irrigation. In this way, the price of water would be inversely tied to the price of carbon credits. The trading of carbon credits is discussed in US2011/0087578 to Finck and Maynard, which is incorporated herein by reference in its entirety.

It is a natural extension of trading water that the water will need to be stored and transported to the place where it is needed. Details of such transport may or may not be part of the exchange between the entities. Alternatively, the details of transport may be decided entirely by the entity holding title to the water. Transport of the water can be made using any means suitable for transporting the water without affecting the quantity and/or characteristics thereof. Examples of water transport devices include, but are not limited to, trucks, planes, ships, pipes, aqueducts, and bags.

In various embodiments, non-rigid structures are utilized to store, transport, and/or convey volumes of water. Applicant hereby incorporates by reference in their entireties U.S. patent application Ser. No. 11/551,125 to Szydlowski, filed on Oct. 19, 2006 and U.S. Provisional Patent Application 61/251,912 to Szydlowski, filed on Oct. 15, 2009. In furtherance of the present disclosure, the following references are incorporated by reference herein in their entireties: U.S. Pat. Nos. 7,500,442 to Schanz, 6,047,655 to Cran, 6,330,865 to Cran, 6,550,410 to Reimers, 5,488,921 to Spragg, 6,293,217 to Savage et al., and 5,197,912 to Lengefeld. In various embodiments, non-rigid structures adapted to contain water are utilized to store, transport, and otherwise accommodate water.

In some embodiments, the present invention utilizes existing systems and devices of water, liquid, and/or gas transport to convey or store water. For example, in various embodiments, devices and systems may be retro-fitted or reconstructed in such a way to safely and efficiently transport large volumes of water. U.S. Pat. Nos. 5,727,492 to Cuneo et al, 5,099,779 to Kawaichi et al., 7,451,604 to Yoshida et al., 4,224,802 to Ooka, 4,331,129 to Hong et al., and 6,997,643 to Wille et al., U.S. Patent Application Nos. 2008/0110091 to Perkins et al, 2005/0095068 to Wille et al., 2009/0126400 to Pozivil, 2005/0276666 to Wille et al., and 2008/0127654 to Darling et al. are incorporated by reference herein in their entireties.

It is yet another aspect of the present invention to provide means for mooring, stabilizing, and/or parking devices adapted for use with the present invention. For example, U.S. Patent Application Publication No. 2004/0157513 to Dyhrberg, which is hereby incorporated by reference in its entirety, discloses a mooring system for mooring a vessel to a floor portion of a body of water. These and similar devices may be incorporated into various embodiments described herein in order to accommodate, for example, issues related to dock or on-shore storage restrictions, weather and tidal conditions, unpredictable transit times, legal and insurance issues related to positioning a device on-shore or at a dock, and physical restrictions associated with shallow water ports. As used herein, a substantially immovable object refers to mooring devices (despite their general ability to drift or float within a certain radius) as well as more traditional fixed objects such as docks, land, anchored vessels, anchors, etc.

One of skill in the art will recognize that where quantities of water are to be stored, degradation of water quality may become a concern. Accordingly, various embodiments of the present invention contemplate a device, which is adapted for preventing growth and propagation of mold, mildew, algae and other deleterious effects caused over time to a quantity of water. By way of example and to further provide support and disclosure, the following references are incorporated by reference in their entireties: U.S. Pat. Nos. 7,731,847 to Huy, 5,229,005 to Fok et al., 4,512,886 to Hicks et al., 6,580,025 to Guy, 7,690,319 to Wingate, 7,686,539 to Aristaghes et al. In various embodiments, methods for maintaining purity and sterility of water are provided. For example, in one embodiment, ultra-violet light is periodically applied to stored quantities of water so as to neutralize or destroy various bacteria, viruses and protozoan cysts such as giardia and cryptosporidia.

In one embodiment, a water storage device of the present invention is adapted for storage in a vertical manner (i.e. wherein a longitudinal axis of a bag is disposed substantially vertically and extending into a depth of a body of water). In this embodiment, the bag or vessel comprises various features for circulating or distributing water throughout. For example, features as described in U.S. Pat. No. 6,580,025 to Guy may be incorporated into storage and transportation devices of the present invention. One of ordinary skill in the art will recognize that when a device is positioned generally longitudinally in a body of water, the lower regions of the device will be cooled due to the water at greater depths being of generally lower temperatures. Accordingly, a device stored longitudinally will generally adopt a thermocline similar to the body of water in which it is disposed, unless acted upon by additional forces/features. Therefore, in one embodiment, convection currents are induced within a water storage device by supplying, for example, thermal energy to a lower portion of the storage unit, thereby causing water in the lower portions of the device to heat, expand, and rise to the top, creating convection currents and reducing deleterious effects caused by allowing a volume of water to remain stagnant.

In one embodiment of the present invention, water is transported in a large water bag. Such bags are made of a suitable material, such as plastic, rubber, nylon, combinations thereof, and the like, and can vary in size depending on the amount of water being transported. Such bags have the advantage of not altering the quantity or characteristic of the water contained therein. To transfer water using such devices, the bags are filled with the water to be transported, sealed and then transferred to the final destination. Any method of moving such bags can be employed. A particularly useful method is to tow such bags through the ocean using ships, barges, tankers, and the like. In one embodiment, unmanned, GPS-guided, boats tow the bags. Such a transport mechanism would reduce the cost associated with a crew.

It is known that when pliable vessels are used to tow or transport volumes of water, wave propagation through the body of water and/or stored volume of water can present undesirable complications. Accordingly, various embodiments of the present invention comprise wave damping features adapted to reduce such effects. For example, various devices and features described in U.S. Pat. No. 7,686,539 to Aristaghes, which is incorporated by reference herein, may be utilized with features of the present invention. For example, wave dampening structures may be disposed within water containing vessels and/or positioned around water containing vessels of the present invention.

In various embodiments, devices of the present invention comprise the ability to convert and/or utilize energy from naturally occurring resources such as solar, wind, wave, and thermal resources. In various embodiments, energy captured and/or converted from these sources may be used for various on-board functions, such as propulsion, heating, and various purification techniques.

In one embodiment, a vessel comprises photovoltaic arrays adapted for converting solar energy into forms of energy which may be used throughout the device and/or system. For example, solar energy may be captured, concentrated, and/or converted in a manner that allows for heating of a submerged volume of water (i.e. via thermal energy, electrical energy, or various combinations thereof) and the subsequent creation of convection currents throughout the system.

In various embodiments, devices for towing water of the present invention comprise energy conversion means such as solar arrays for powering various devices. Devices of the present invention comprise towable bags or bladders with a surface of up to 60,000 square meters. As it is known that the power density of the sun's radiation on the surface of the earth is approximately 1.4 kW/m², devices of the present invention are impacted by incredibly large amounts of energy. As such, it is contemplated that devices of the present invention comprise features for harnessing this energy, as well as additional sources of energy such as wind and wave action, to power various on-board features.

In one embodiment, natural sources of energy are harnessed to power various functions such as moving and/or circulating water through a bag, forming an electric barrier around the bag to deter various creatures, powering lighting elements, GPS units, and rudders, and even providing propulsion for the device itself. It is further contemplated that power systems aboard a towing device (e.g. tug boat) may be synced with powered devices of a bag unit so as to supplement one or the other.

In various embodiments, bags of the present invention are provided with dispersion means for repelling various creatures such as birds, seals, sea lions, whales, mussels, mollusks, octopi, and various other marine and avian creatures. Various creatures and sea life can produce serious detriment to bags and/or to ecosystems to which they may be transported in the event that they use the bag as a “host.” Accordingly, in order to solve the long-felt need of repelling such life forms from towed bags, the present invention provides electrically powered means for dispersing such creatures. Such electrically powered means may be powered by various on-board energy devices as discussed herein or may derive power from elsewhere, such as an attached vessel. In one embodiment, features are provided along a surface of the bag to repel various creatures. For example, in one embodiment, a plurality of sprinklers is provided to prevent fowl from congregating on a bag and compromising the hygiene of the same. In another embodiment, flashing or strobe lights are provide to prevent unwanted creatures from inhabiting devices of the present invention.

Another aspect of the present embodiment also includes loading tankers with water through very large bags of water. These bags of water may be brought to where the tanker has unloaded its cargo. Alternatively, these “water islands” can be positioned at various predetermined locations and after an tanker has delivered its cargo, it can then travel to one or more water islands to then take water on-board and then continue to a destination where such water is desired. The water may also be loaded through buoys or filled by lighters, which are smaller tankers. These loading techniques significantly reduce the cost of loading the water because it minimizes the large tankers' travel. For example, U.S. Pat. Nos. 7,841,289 and 7,500,442 to Schanz, which are hereby incorporated by reference in its entirety, discloses water transporter and storage systems for liquids, such as water, by means of a very large bag-like structure. In various aspects of the present invention, methods and systems employ a lightweight towed submerged water transporter and storage system for liquids, which employs a streamlined towable hull with optional air and liquid storage bladders used not only to adjust buoyancy, but to allow the simultaneous transport and storage of different solids and liquids.

In one embodiment of the present invention, the ice itself can be transported to an agreed upon location. In such embodiment, ice in the required volume and having the desired characteristics, would be removed from the glacier or ice cap, and transported directly to the agreed upon location. Transport of such ice could be achieved in several ways. For example, the ice could be allowed to melt during transport such that upon arrival, it is in a liquid form and ready for consumption. Alternatively, the ice could be kept frozen such that it arrives at its final destination in its original form. Such transportation can be achieved using technology known to those in the refrigeration arts.

In one embodiment of the present invention, the water is transported to a different geographical location than where it is sequestered, without affecting the characteristics of the water. In one embodiment, the water is transported at least 10 miles, at least 250 miles, at least 500 miles, at least 1000 miles, or at least 10,000 miles, from the location where it is sequestered. Such distances can also be measured using kilometers, nautical miles, and the like.

According to the present invention, tankers can also be used to transport water of the present invention. Ballast space, cargo space, or combinations thereof can be utilized. When a vessel's cargo hold is empty or partially empty, the vessels use ballast water weight to maintain stability to compensate for a lack of cargo weight. The vessel is equipped with ballast tanks that can be filled with water (typically sea water for ocean going ships and tankers) to maintain stability when the vessel travels empty. The ballast tank water is then typically discharged when the cargo, such as oil, is loaded. By way of example and in further support of the present disclosure, U.S. Patent Application Publication No. 2006/0027507 to van Leeuwen; US Patent Application No. 2006/0027507, which is a CIP of issued U.S. Pat. No. 7,273,562 to Robinson, which is a CIP of issued U.S. Pat. No. 6,869,540 to Robinson, are all incorporated herein by this reference in their entireties.

Prior to loading their cargo, the tankers must discharge the ballast water; therefore a productive use of this deadheading portion of a tanker's round trips would be to carry water from a fresh water source, melt water, or outflow river water to the tankers home port in an oil-rich but water-poor region. By way of example and in further support of the present disclosure, U.S. Patent Application Publication No. 2011/0036919 to Baird, is incorporated herein by reference in its entirety.

In one embodiment, water is used as ballast water weight in a large sea vessel, such as an oil tanker. After the oil tanker unloads its oil cargo at its destination, water is injected into the vessel's ballast tanks, the water is fully or partially treated, and the water is unloaded at the vessel's oil-loading port for human use, irrigation purposes, or other use requiring such water. In the present embodiment, the water is not released into the port, but rather the water is unloaded for use on land or onboard other ships, thus solving the problem of discharging non-native microorganisms and bacteria into the port's water. Furthermore, the water loaded into the ballast tanks can be either drinkable or undrinkable water. Either way, one skilled in the art can imagine different embodiments for treating the ballast water: the water can be treated while the tanker is in route, upon the tanker's arrival but before the water is unloaded, or the water can be treated once on land.

Crude oil tankers either fill “empty” cargo tanks with ballast water or fill dedicated ballast water tanks with water for their return trips. When an empty crude oil tank is filled with ballast water that water is typically referred to as “unsegregated” or “dirty” ballast because the ballast uses the same tanks as the crude oil rather than a separate tank. Most new tankers are designed with segregated ballast tanks, but a few older tankers are only able to carry unsegregated ballast. One embodiment of this invention is to use water of the present invention as ballast in oil tankers deadheading to the water-poor regions of the world.

Various methods may be employed to fully treat or partially treat the ballast and/or transported water as it is entering the ballast tanks, sitting in the ballast tanks, or as it is removed from the ballast and/or transport tanks. One such method for partially treated the ballast water is ozonation. Ozonation has been found to be a safe and effective disinfectant method and system to treat ballast water. Ozone can be spayed into the ballast water tanks before the ballast tanks are filled. Ozone can also be used as an in-line treatment of loading and/or unloading ballast water. This in-line method can comprise injecting ozone into a line of water loading into a sea faring vessel prior to charging the water into a ballast tank; charging the ozone injected water into the ballast tanks; and adjusting a rate of injection of the ozone into the water and adjusting the rate of water loading into the vessel to provide a target biokill of species within the water. In-line ozonation is said to be more efficient and more economical than in-tank treatment. By way of example and in further support of the present disclosure, U.S. Pat. No. 6,869,540 to Robinson and U.S. Pat. No. 6,125,778 to Rodden are incorporated herein by reference in their entireties.

In one embodiment, a treatment system to treat ballast water using a membrane treatment unit to separate out microorganisms is employed. Such a system is described in U.S. Pat. No. 7,900,780 to Ueki and U.S. Patent Application Publication No. 2007/0246424 to Hironari, which by way of example and in further support of the present disclosure, are incorporated herein by reference in their entireties.

Other embodiments employ one or more of a UV system for disinfecting ballast water (WO 02/074,692); chlorine dioxide (WO 02/44089) or pesticides (EP 1,006,084 and EP 1,447,384); at least one filter unit, at least one disinfection unit, and a detection unit (U.S. Patent Application Publication No. 2010/0116647); the infusion of combustion gases into the ballast water to kill harmful microorganisms and bacteria (U.S. Patent Application Publication No. 2011/0132849); as well as various other systems such as those found in U.S. Patent Application Publication No. 2010/0116647 to Kornmuller, U.S. Patent Application Publication No. 2011/0132849 to Husain, WIPO Patent Application Publication No. 02/074,692 to Brodie, WIPO Patent Application Publication No. 02/44089 to Perlich, European Patent Application Publication No. 1,006,084 to Fuchs, and European Patent Application Publication No. 1,447,384 to Hamann, all of which are incorporated herein by reference in their entireties.

In another embodiment, water treatment systems are employed on the oil tanker or other cargo vessel to treat the ballast and transported water as the vessel is making its return voyage. The system could treat and clean the water in one ballast tank, move the treated water to a second ballast tank either during the treatment process or after the treatment process, and then treat the water in the second ballast tank, and so forth. The very large bags as otherwise described herein can also be used to store water after water treatments, whether such bags are then further towed to a destination land port or alternatively moored in “water islands” at a predetermined destination.

It is also known that tanker ships are used to transport various liquids such as chemicals, oil or liquid natural gas (LNG). Such ships were heretofore considered unfit for the transport of water. However, because of the inventor's realization that various grades of water exist, and that such water can be treated en-route to change its grade, one aspect of the present invention is that such ships can be used to transport water.

In various embodiments, LNG shipping containers are utilized to transport large quantities of water. It is known that LNG shipping containers have enjoyed a history of stellar safety. It is estimated that LNG tankers have sailed over 100 million miles without a shipboard death or even a major safety incident. Although water generally does not pose any environmental or significant safety risks in the event of an accident or spill, it is clearly desirable to protect all cargo from risk of loss, contamination, or general diminution in value.

In certain embodiments, the present invention contemplates devices, methods and systems for utilizing pre-existing Liquefied Natural Gas (“LNG”) tankers in a manner that allows the ships to be returned to a point of origin or another location with fresh water after some or all of a payload of LNG has been delivered. Thus, in various embodiments, a novel gas-water exchange system is provided. It is known that LNG tankers may comprise volumes of up to 225,000 cubic meters. Accordingly, in various embodiments, re-filling even a portion of a LNG container with potable water can result in provision of a significant amount of highly demanded water to a point of origin or alternative location. As many LNG tankers currently deliver a payload and return empty, re-supplying such vessels with water not only provides economic viability for an otherwise empty return voyage, but also increases the ship's ballast and fuel efficiency.

In one embodiment, one or more bladders are provided wherein the one or more bladders are adapted to be placed within an emptied volume of a LNG shipping container (i.e., tank, hull, etc.) and further filled with water to provide ballast and/or valuable shipping contents for a return or additional voyage. Accordingly, in various embodiments, significant value is provided to shipping activities by supplying a vessel with a valuable return-shipment, such as water. In one embodiment, at least portions of LNG contained within a LNG tanker are emptied or extracted at the appropriate location (e.g. a regasification plant).

Thereafter, emptied portions of a LNG shipping vessel or container are provided with a liner suitable for preventing or minimizing contamination from previously and/or contemporaneously stored gas. For example, various liners available from Fab-Seal Industrial Liners, Inc. may be provided to accommodate water to be stored within a LNG tank and isolate the water from various materials, gases, debris, etc. Liners suitable for use in the present invention include, but are not limited to, P.V.C. flexible membrane liner materials.

In various embodiments, bags or liners for isolating water or liquids may be fabricated in any desired manner, including in a completely flattened conformation. For example, two sheets of fabric may be cut to the desired plan shape and joined at their adjacent edges by suitable means consistent with the material of construction. For example, heat welding or solvent welding may be used if certain polymeric materials have been employed as the substance coating the fabric. Sewing may be necessary in addition. It is possible that the overall cost of a bag may be reduced if the center section and the edges are fabricated separately, i.e., not the flattened conformation. In various embodiments, the bag is not a body of revolution or, in particular, tubular.

In various embodiments, the top and bottom surfaces are indistinguishable and the bag or liner may be periodically turned over to equalize damage due to sun, weather, mold, aging, etc.

In various embodiments, liners of the present invention comprise a water-resistant, elastomer-coated mesh material, such mesh material being constructed of polymeric material having some inherent elasticity, such as polyester or nylon. A warp knit mesh construction is preferred in certain embodiments. The mesh material also may be steel mesh, preferably hexagonal netting of drawn steel wire or similar high modulus material, such as extended-chain crystallized polymer.

In various embodiments, the base fabric is provided with an elastomeric coating for the purposes of providing water-proofing as well as protecting the material of construction from ultraviolet degradation and marine growth.

In one embodiment, internal surfaces or portions may be coated with various materials to prevent or minimize risk of cross-contamination. For example, various spray-coatings may be applied once a quantity of LNG is emptied from a portion of the vessel to create a virgin surface for the holding and contacting with water or similar fluid cargoes. By way of example, industrial water-proof coatings provided by the Procachem Corporation may be provided to coat, cover, or seal a surface that was exposed to or in contact with LNG so as to render the surface capable of accommodating water without significant risk of cross-contamination. In various embodiments, internal volumes of storage tanks or similar structures are coated with a layer of material, the layer of material comprising an appropriate thickness to substantially eliminate the risk of cross-contamination between a liquid or material to be stored and a liquid or material previously stored in the same tank. In various embodiments, the layer of material applied is not so thick as to substantially impact the overall internal volume of the container, tank, vessel, etc.

In one embodiment, one or more tank cleaning apparatus are employed to cleanse the inside of a container or tank. For example, various features as shown and described in U.S. Patent Application Publication No. 2009/0308412 to Dixon, which is incorporated by reference herein, may be employed to prepare various LNG shipping tankers and similar containers for the transport of cargo other than LNG.

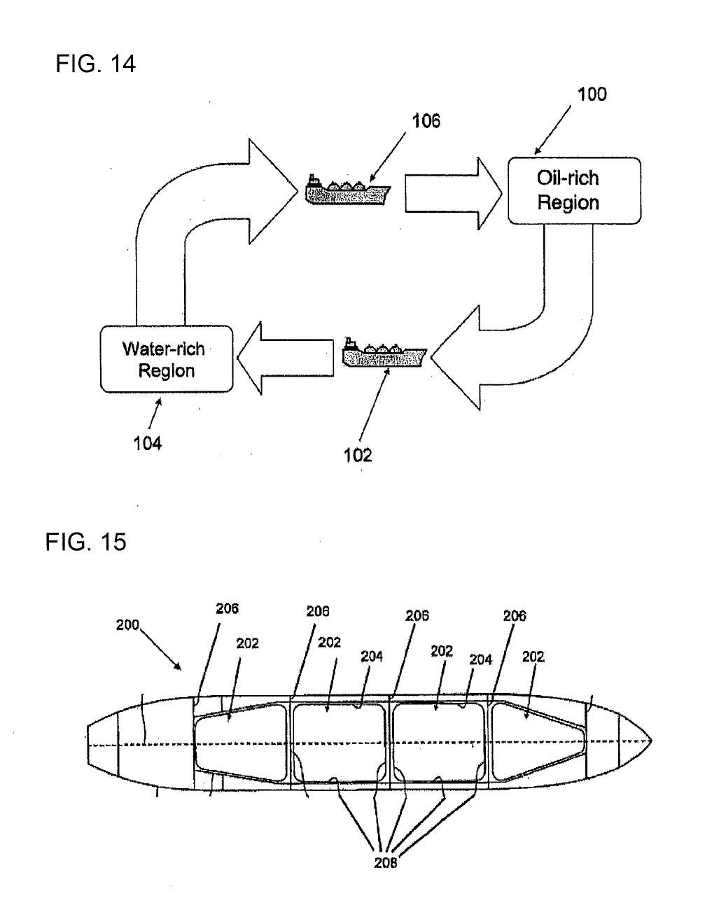

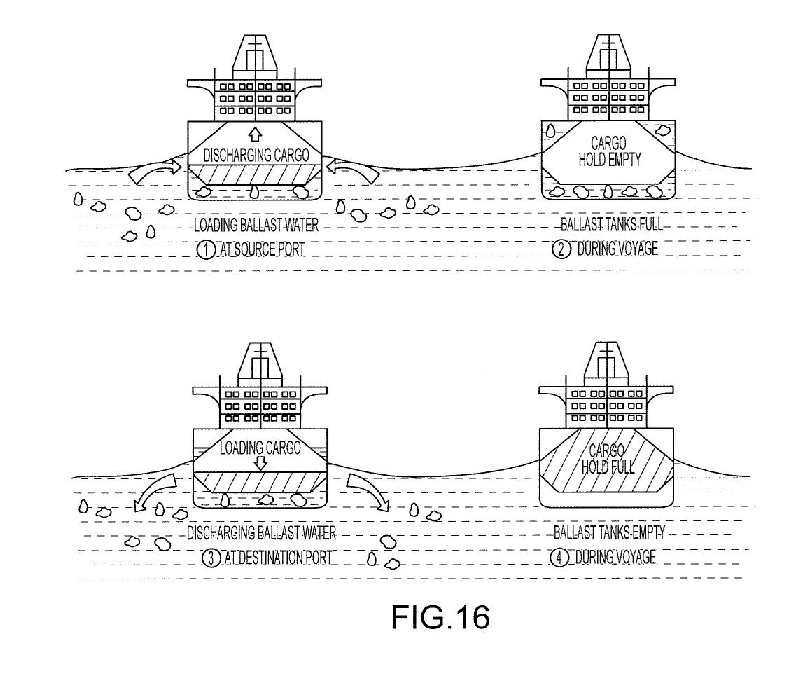

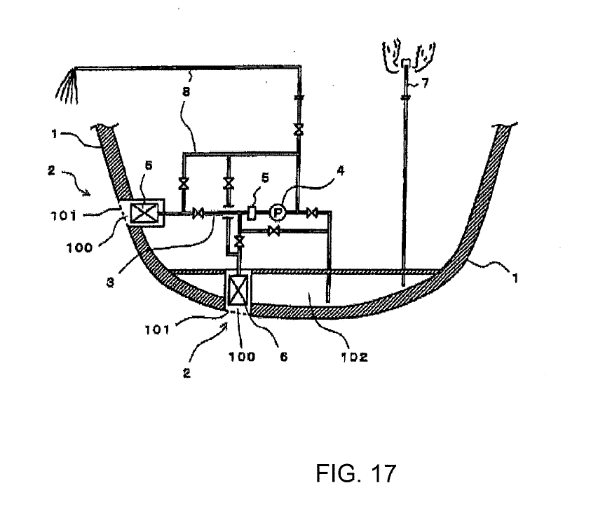

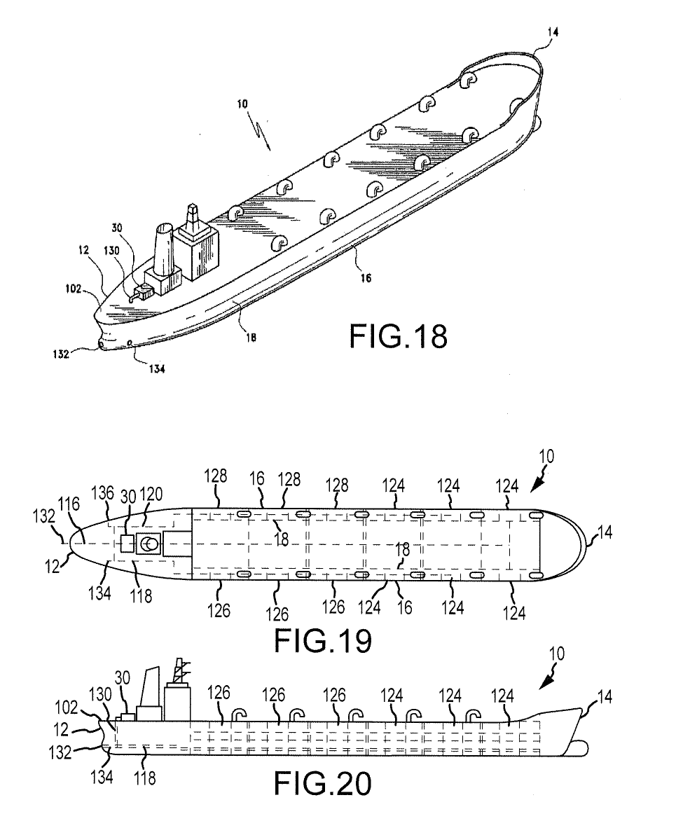

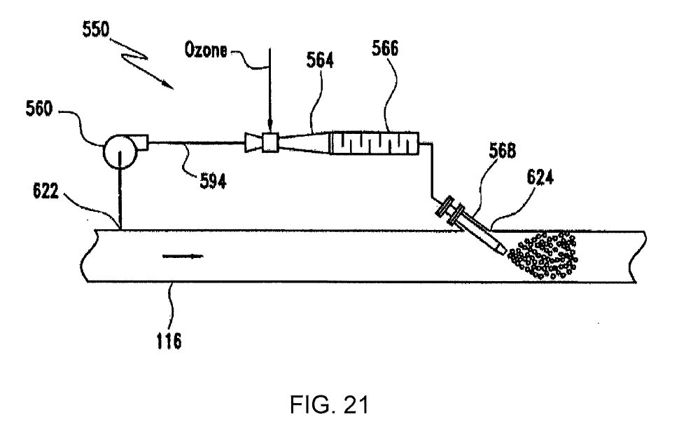

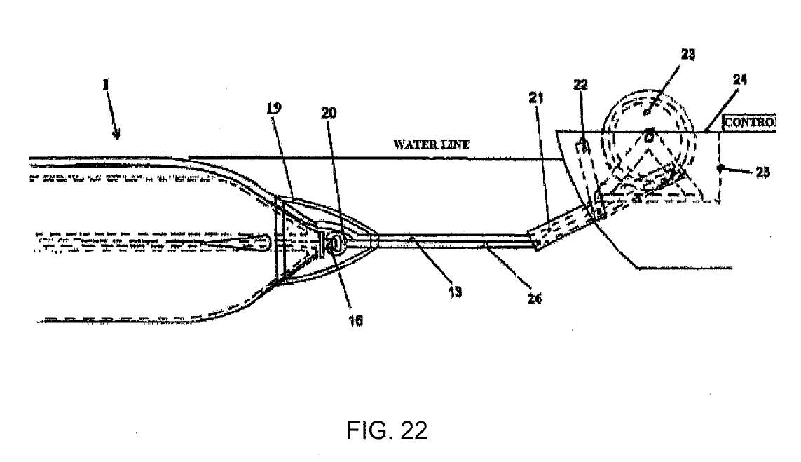

FIG. 14 depicts one embodiment of the present invention wherein a LNG tanker 102 is utilized to transport LNG from a country, region, or port 100 rich in such resources to a region having a demand for LNG 104. In one embodiment, the region having demand for LNG 104 also comprises a supply of fresh water or similar liquid having value. In various embodiments, such a liquid is transported from the region 104 back to the LNG origin 100 or to various other destinations by utilizing features, volumes, and functionality in a vessel that previously conveyed water 102 from the LNG-rich region 100. Thus, in one embodiment, shipping vessels are utilized to convey two or more resources from one location 100 to another 104 in a generally cyclical manner, increasing efficiency of the overall transportation method.

One of ordinary skill in the art will recognize that water or similar liquids need not be conveyed directly back to a vessel's origin. Indeed, in various embodiments, a vessel 102 used to convey LNG or similar product to a region 104 may be supplied with a quantity of water or another cargo and thereafter transported to another destination (not shown). In various embodiments, the water-rich region 104 is not the same region having a demand for LNG or similar products. Accordingly, LNG may be conveyed from a source or origin 100 to a port or location in need of the same (not shown). The LNG tanker may then be routed to a water-rich region 104 for acquisition of water or similar and directed to various locations in need of the same.

One of skill in the art will recognize that the regions of the world which are generally endowed with large LNG supplies have a similar dearth of water supplies. Accordingly, various embodiments of the present invention contemplate utilizing LNG shipping technology to provide water upon return voyage. However, as will be recognized, various trade routes, diversions, off-shoots, etc. are contemplated herein. According to various embodiments, water and LNG are transported to and from any number of ports or locations, with shipping efficiency provided by the ability to utilize existing tankers and/or equipment for a variety of different liquid cargoes.

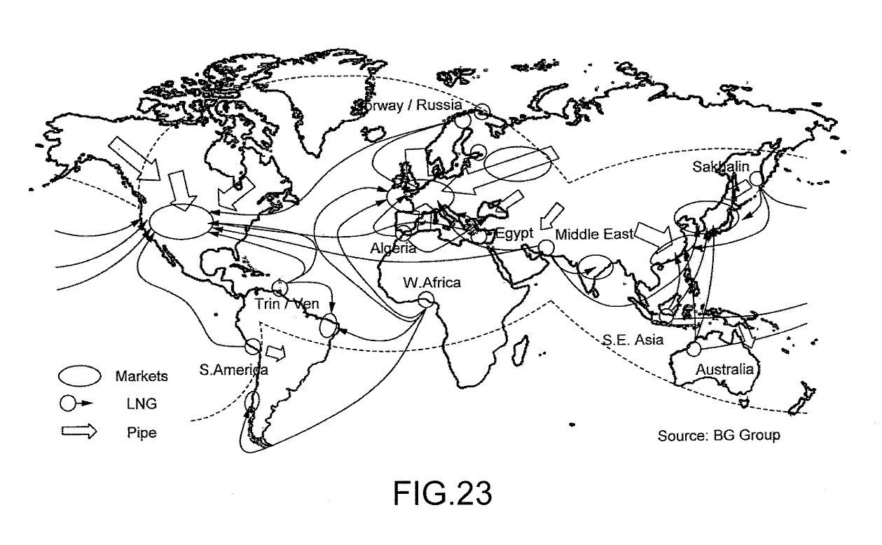

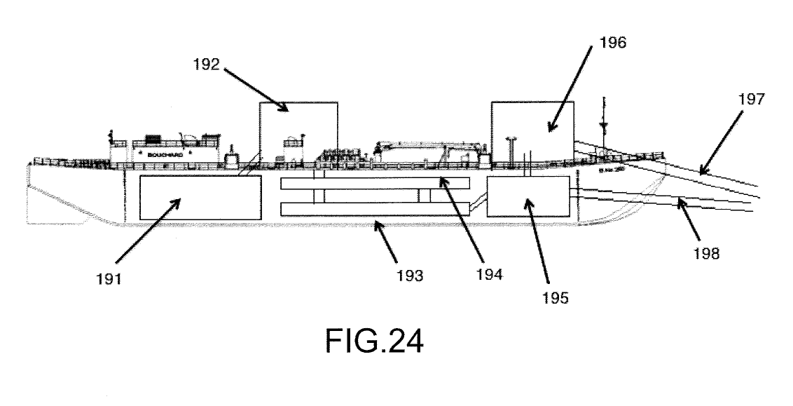

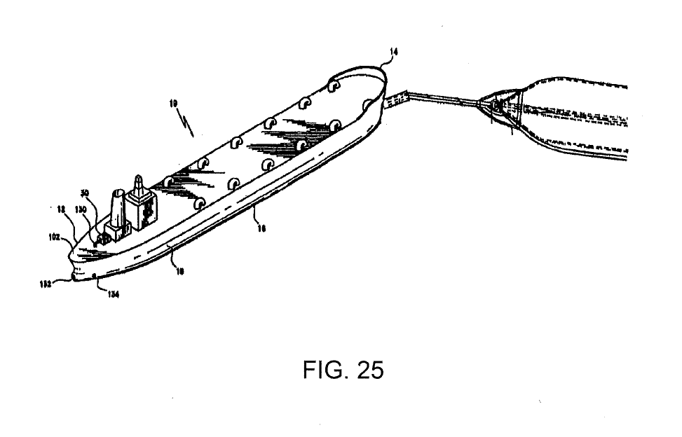

FIG. 23 depicts various trade and supply routes of LNG. It will be recognized that a number of locations depicted have substantial need for water and will continue to experience such need as demand grows. Furthermore, many of these water-depleted regions currently export or have the potential to export LNG and other supplies via large tankers or ships. Given the finite number of LNG tankers and similar vessels in operation, these vessels will obviously need to return to a point of origin at some time in their career. Various embodiments contemplate returning these vessels with quantities of water suitable for drinking, agriculture, sanitation, and/or various other purposes. As used herein, the term “fresh” with respect to water need not necessarily mean potable. Rather, it will be recognized that “fresh” is merely a term for the alternative to salt water.

FIG. 15 is a top plan view of a shipping container 200 with one or more internal storage volumes 202. In various embodiments, internal storage volumes 202 are adapted to house large volumes of LNG in a first state and accommodate large volumes of water or various other liquids in a second state. In one embodiment, one or more drop-in liners 204 are provided after LNG is emptied from portions 202 of a vessel 200, the liner(s) being adapted to receive volumes of water or liquid. The liner(s) prevent or mitigate the risk of cross-contamination between the water and previously stored LNG. In various embodiments, portions 202 of a LNG tanker are segregated by barriers 206. Barriers 206 allow for separation of various liquid cargoes. Accordingly, in various embodiments, tankers of the present invention may comprise or transport various combinations of liquid cargoes based on user preference. As one of skill in the art will recognize, an entire shipment of LNG need not be offloaded in order to transport different cargo. For example, two of four compartments comprising LNG may be offloaded at a particular port, the emptied two compartments re-filled with a volume of water, and the vessel may be conveyed to an additional port carrying a combination of LNG and water (or similar). Accordingly, in various embodiments, a dynamic shipping method is provided which may comprise different quantities and types of liquids based on shipping routes, economic conditions, and various other factors.

In one embodiment, one or more tank cleaning apparatus are employed to cleanse the inside of a container or tank that housed LNG. For example, various features as shown and described in U.S. Patent Application Publication No. 2009/0308412 to Dixon, which is incorporated by reference herein, may be employed to prepare various LNG shipping tankers and containers for the transport of cargo other than LNG.

One of skill in the art will recognize that various methods and devices of the present invention are not limited to LNG shipping tanks or tankers. Indeed, various methods, features, and systems as described herein may be utilized with a variety of shipping containers and vessels, including, but not limited to, war-ships, recreational vessels, bags, cargo-ships, etc.

One of skill in the art will recognize that various methods and devices of the present invention are not limited to LNG shipping tanks or tankers. Indeed, various methods, features, and systems as described herein may be utilized with a variety of shipping containers and vessels, including, but not limited to, war-ships, recreational vessels, cargo-ships, etc.

Also contemplated is the use of oil tankers for transporting water. In one embodiment, fresh water is at least transported as ballast in tankers. In one embodiment, the water is transported in oil tankers deadheading to homeports. In a particular embodiment, such deadheading can be from the oil-rich but water-poor areas of the world. An objective of this invention is to use carbon free, renewable energy sources to at least partially treat transported water in route or at a water-poor region.

In various embodiments, systems and methods are employed on an oil tanker ship to treat vast quantities of water within the ship's hull and/or ballast tanks and/or tugged barges, and/or very large bags, etc. while the ship is in its return transit to re-fill with oil. Traditionally, large tanker ships return to oil-bearing nations across the seas with an empty hull and ballast tanks full of seawater because it was considered impracticable to transport water, particularly drinkable water, in such oil-contaminated hulls. One aspect of the present invention, however, relates to the provision of systems on such tankers such that water can be hauled back to the typically water-starved regions of the world from whence oil is extracted and shipped, with such water being treated on-board ship so as to deliver potable water upon arrival at the return destination. In certain embodiments, the water is only partially treated in a fashion that permits it to be fully treated at the destination port, thus lessening the time and costs involved of performing all water treatments upon arrival. In other embodiments, however, the transported water is largely or substantially treated in a fashion so that minimal additional treatment is required at the destination port. One of skill will appreciate the various and multiple treatment steps that may be included during transport of the water in view of differing conditions, facilities, type and quality of water, type of oil residues, the capacity to segregate treated water from untreated water, etc. Various types of oil removing systems can be employed within the scope of the present invention, with preferred systems being those that can readily be installed aboard an oil-tanker vessel. As many oil tankers currently deliver a payload and return empty, re-supplying such vessels with water not only provides economic viability for an otherwise empty return voyage, but also increases the ship's ballast and fuel efficiency.

In various embodiments, a method of shipping/transporting water is provided, the method comprising a first location, a second location, and a shipping vessel. In particular embodiments, the first location comprises substantial quantities of oil and the second location comprises substantial quantities of fresh water. Shipping vessels of the present invention may therefore be provided with cargo comprising oil at a first location and transported to a second location. Subsequently, in various embodiments, a shipping vessel is at least partially emptied of the cargo comprising oil and provided with cargo comprising water at the second location. In various embodiments, the shipping vessel is repeatedly transported from the second location back to the first location.

One focus of the various embodiments of the present invention is to address the long-felt but unsolved need in the industry for a reclamation process for treating undrinkable but available water that is transportable in oil tankers such that water can be delivered to water-starved regions of the world where such oil tankers frequently return. The ability to reduce the need to desalinate water at the point of commercial use is urgently needed, not only due to the significant costs associated with such land-based plants, but also due to the political and military risks that such water treatment plants have in the politically volatile areas of the middle east where water is most needed. The bombing of an expensive water desalinization plant by an enemy would result in tremendous instability to local populaces. The present invention provides a significant secondary source of vital water supplies so that such a prospect is not used by competing nations to achieve political or military aims.

In one embodiment, water treatment systems include those that are suited to reclaim waste fluids in a continuous flow fashion for treatment within a ship positioned container, whether on-board the tanker or on a ship that may meet the tanker at the destination port. Some systems employ immersible transducers producing ultrasonic acoustic waves in combination with a high level of injected ozone. Water can also be treated by directing it into a ship positioned centrifuge for enhanced solid waste removal. Preferably, such systems are mobile and containerized and suitable for installation aboard an oil tanker ship and/or on an accompanying vessel at the destination port.

In practice, the difficulties of separating oil-contaminants from water to arrive at suitable water will vary to some extent on the nature of the kind, degree and type of contamination of the water resulting from the tanker compartments. It will also depend on the intended final use of the water. For example, water intended in uses such as, for example, hydraulic fracturing (“fracking”), may require minimal or even no processing. In contrast, producing drinking water from such contaminated water will require more extensive processing. Various water treatment systems and methods, however, can be used to achieve desired water quality standards. For example, oftentimes water from the hull of an oil tanker will need to first be clarified and separated from substantial amounts of suspended and emulsified oil, bitumen and other impurities like salts, silica, etc. To achieve this end, a high intensity acoustic energy and triatomic molecules can be introduced into the water via a conditioning container to provide a mechanical separation of materials by addressing the non-covalent forces of particles or, van der Waals force. The conditioning tank may provide a first level of separation including an oil skimmer through an up flow configuration with discharge entering a centrifuge. Water from the centrifuge may then be directed through a filtration process, sand or multimedia, for removal of large particulates before introduction through activated carbon filters for removal of organics and excess ozone. Discharge from the carbon filters is directed to a clean water tank. Piping can be employed to transport water to very large bags (as otherwise described herein) to accompanying vessels at a destination port or directed to onshore treatment and/or storage systems.

The instant invention provides for a cost efficient and environmentally friendly process and apparatus for cleaning water transported in an emptied oil tanker without the traditional concerns for cleaning the confines of the oil tanker so as to make it suitable for transport of potable water. Such a task has been, and admittedly is, an expensive and technologically, time-consuming and impractical exercise. What is needed, and what the present invention provides, is a method and system to achieve the ultimate goal of having drinkable water delivered to water starved but oil rich regions without the need to thoroughly clean the interior confines of an oil tanker ship prior to transport. Moreover, the oil tankers used throughout the world are huge vessels that have excess power capabilities, which can run water purification systems onboard and while in transit. Thus, without entailing additional valuable time that would be required to clean the confines of a tanker so that it could potentially carry varying degrees of “clean” water on a return trip to be re-loaded with oil, the present invention provides a method and system for cleaning water conveyed in the hulls and ballast tanks of such tankers while the tankers are on the open sea, utilizing the power of the internal ship systems to run the water treatment processes as described herein.

Thus, one aspect of the present invention is directed to the provision of an on-ship (e.g. oil tanker vessel) on-site process to treat water contaminated with oil residues remaining after an oil tanker ship is emptied of its oil cargo. One will also appreciate, however, that while the present invention finds particular application in the use of oil tankers, especially in view of their abundance, size, sophistication and the fact that they traverse between oil rich and water rich countries, other container or transport ships can also be utilized for various embodiments of the present invention, e.g those transporting other fluids, grain, produce, etc.

One objective of the invention is to provide an on-ship process that will lessen the time required to treat water on-site and will lower the cost of water to consumers by reducing the current and expensive land based processes used for the provision of water in water-starved regions of the globe.

In one embodiment, the treatment of oily water comprises adding an effective amount of a natural coagulant selected from the group consisting of tannins, chitosan, and a cationic or anionic flocculants. Preferably, the pH of the oily water is optionally adjusted to a range of about 2 to 8, prior to the natural coagulant being added, preferably the pH adjusted to between about 6.5 to 10 subsequent to the addition of the natural coagulant. Oil contaminated water is preferably separated in a mechanical separation process such as in flotation, filtration, reverse osmosis, cyclonic, gravity separation, and centrifugal force separation devices. One such device that may be employed is available from Enviro Voraxial Technology, Fort Lauderdale, Fla. The oily water can also be purified through the use of a purification apparatus and an operation method therefor, for coagulating and separating particularly the pollutant matter in water including oil and the like, which can regenerate and reuse the coagulant within the apparatus, without scarcely resupplying the coagulant. By way of example and in further support of the present disclosure, U.S. Pat. No. 7,410,573 to Norihide is incorporated herein by reference in its entirety.

In another embodiment the treatment and purification of oily water involves two steps: (1) pretreating the oily water to remove the organics, algae, fine particles, oil, gas, and waste material; and (2) treating the non-drinkable water to make potable water. Any conventional process can be used for the pre-treatment in step one. One such example is using a mobile water-treatment plant on a converted oil tanker that separates out contaminants as by settling, to leave clean water that can then be transferred to step two of the process and contaminants that must be disposed of once the tanker arrives at its port. Natural filtration is used in other embodiments, such as by subjecting oily water in the oil tanks to natural filtration techniques, such as those identified in U.S. patent application Ser. No. 12/905,590, incorporated herein by this reference. Other methods include reverse osmosis and multi-stage flash exhibit.

Both reverse osmosis and multi-stage flash exhibit lower performance in produced or fracking water treatment, where a much higher salinity in the produced or fracking water increases energy consumption and causes increased membrane fouling. By instead mixing the oily water with the directional solvent, most of the water can be extracted in substantially pure form using relatively low energy and heat inputs and at a reasonable cost, leaving a much more concentrated and lower volume waste product and allowing the extracted water to be conveyed to population centers or stored in vessels, very large bags, etc. By way of example and in further support of the present disclosure, WIPO Patent Application Publication No. 2011/066193 to Bajpayee is incorporated herein by reference in its entirety. Additionally, a mobile water treatment apparatus that includes a filtration system, a motor, a fluid storage container, and a fluid delivery pump is used to treat the water onboard the tanker and/or in an associated water treatment barge at or near the destination port. By way of example and in further support of the present disclosure, U.S. Patent Application Publication No. 2011/0089123 to Kennedy is incorporated herein by reference in its entirety. High temperature electrolysis to dissociate water to hydrogen and oxygen may be used and to separate the non-water material, and the combusting of generated hydrogen and oxygen at elevated pressure forms a high pressure high temperature superheated steam, creating a closed loop heat recovery system to recycle the heat generated by the combustion process to the high temperature electrolysis unit for the dissociation of non-fresh water. The standard requirement for eliminating hazardous material in typical incineration process is by keeping the material at 2000 degrees Celsius for at least two seconds. The present system in one embodiment provides such conditions for oily, pretreated water. By way of example and in further support of the present disclosure, U.S. Patent Application Publication No. 2010/0272630 to Rosenbaum is incorporated herein by reference in its entirety.

In one embodiment, the on-board treatment of oily water is performed by an apparatus that includes a funnel, a system effective for achieving submersion of a majority of the slant height of the funnel within the carrier fluid, and a pump in fluid communication with the interior volume of the funnel proximate the smaller end of the funnel for pumping fluid collected at the smaller end of the funnel. By way of example and in further support of the present disclosure, U.S. Patent Application Publication No. 2009/0314725 to Parro is incorporated herein by reference in its entirety.

In another embodiment of the present invention, an oil tanker ship has a purification treatment unit disposed on the hull and configured to collect, purify, and treat oily water (e.g. the water stored in the empty, dirty oil tanks). The purification treatment unit includes a floated oil collecting tank to collect floated oil collected from water in a dirty oil tank, a stirring tank having a cylindrical straight drum and a funnel-shaped bottom to stir oily water taken out from the dirty oil tank together with a coagulant and a collecting path to discharge precipitates, a plurality of filter treatment tanks to be used in multistage filtering treatment of oily water in the stirring tank, and purified water tanks. By way of example and in further support of the present disclosure, U.S. Patent Application Publication No. 2011/0147293 to Imahashi is incorporated herein by reference in its entirety.

In the production of oil and gas, great quantities of water are produced. The water produced by the process is called “produced water” and often contains hydrocarbon and other materials. Of particular concern for use in common well-treatment operation is the avoidance of water containing undesirably-high concentrations of inorganic ions having a valence state of two or more. As one aspect of this invention, water pumped into an oil tanker's dirty, but empty, oil tanks is without undesirably-high concentrations of inorganic ions having a valence state of two or more. The purpose for this pre-treatment is to prevent deterioration of the oil refilled in the oil tankers after the water is removed. By way of example and in further support of the present disclosure, U.S. Patent Application Publication No. 2010/0319923 to Slabaugh is incorporated herein by reference in its entirety.

In various embodiments, devices of the present invention comprise the ability to convert and/or utilize energy available not only from the oil-empty tankers in route to oil ports, but also from naturally occurring resources such as solar, wind, wave, and thermal resources. In various embodiments, energy captured and/or converted from these sources may be used for various on-board functions, such as propulsion, heating, and various purification techniques.

In one embodiment, non-drinkable water (non-salt water) is loaded into the oil tanks of an empty oil tanker after the tanker has unloaded the oil at the desired location. This water could then be treated by the methods mentioned above, and after the water is cleaned it is put into the ballast tanks of the oil tanker. Clean ballast tanks could hold the treated and drinkable water without re-contaminating the water. The drinkable water could then be unloaded at the tanker's next destination before the tanker is refilled with oil.

While an emphasis of some embodiments of the present invention are directed to the ability to utilize recently emptied oil tankers to deliver non-salt water back to destinations other than the destination where oil was delivered, it is considered a teaching away from conventional thought to simply fill an empty oil tanker with fresh water as the water would immediately become fouled with the remaining remnants of oil and oil debris left over from the coatings on the tanker's internal surfaces. Thus, conventional wisdom was that such oil tankers, large as they are and despite the need for water to be transported to water-starved regions, were not believed to be viable candidates due to the time and expense of having to somehow clean or coat the internal surfaces of oil tankers so as to preclude water contamination. But in various embodiments of the present invention, such cleaning or coating methods may be employed in certain circumstances so as to at least lessen the ultimate task of cleaning the water either en route or at its final destination. Thus, while not necessarily being the preferred embodiment, various embodiments employ systems and methods whereby internal surfaces or portions of transport ships, and in particular oil tankers, may be coated with various materials to prevent or minimize risk of cross-contamination (i.e. the oil residue contaminating the water and vice versa). For example, various spray-coatings may be applied once a quantity of oil is emptied from a portion of the vessel to create a virgin surface for the holding and contacting with water or similar fluid cargoes. By way of example, industrial water-proof coatings provided by the Procachem Corporation may be provided to coat, cover, or seal a surface that was exposed to or in contact with oil so as to render the surface capable of accommodating water without significant risk of cross-contamination. In various embodiments, internal volumes of storage tanks or similar structures are coated with a layer of material, the layer of material comprising an appropriate thickness to substantially eliminate the risk of cross-contamination between a liquid or material to be stored and a liquid or material previously stored in the same tank. In various embodiments, the layer of material applied is not so thick as to substantially impact the overall internal volume of the container, tank, vessel, etc. Thus, in certain embodiments, one or more tank cleaning apparatus are employed to cleanse the inside of a container or tank. For example, various features as shown and described in U.S. Patent Application Publication No. 2009/0308412 to Dixon, which is incorporated by reference herein, may be employed to prepare various oil tankers and similar containers for the transport of cargo other than oil.

In still other embodiments, one or more bladders are provided wherein the one or more bladders are adapted to be placed within an emptied volume of a oil shipping container (e.g., tank, hull, etc.) and further filled with water to provide ballast and/or valuable shipping contents for a return or additional voyage. Accordingly, in various embodiments, significant value is provided to shipping activities by supplying a vessel with a valuable return-shipment, such as water. In one embodiment, at least portions of oil contained within an oil tanker are emptied or extracted at the appropriate location. Thereafter, emptied portions of an oil shipping vessel or container are provided with a liner suitable for preventing or minimizing contamination from previously and/or contemporaneously stored gas. For example, various liners available from Fab-Seal Industrial Liners, Inc. may be provided to accommodate water to be stored within an oil tank and isolate the water from various materials, tar, oil, debris, etc. Liners suitable for use in the present invention include, but are not limited to, P.V.C. flexible membrane liner materials.

In various embodiments, bags or liners that may find use in certain situations are designed for isolating water from oil surfaces and may be fabricated in any desired manner, including in a completely flattened conformation. For example, two sheets of fabric may be cut to the desired plan shape and joined at their adjacent edges by suitable means consistent with the material of construction. For example, heat welding or solvent welding may be used if certain polymeric materials have been employed as the substance coating the fabric. Sewing may be necessary in addition. It is possible that the overall cost of a bag may be reduced if the center section and the edges are fabricated separately, i.e., not the flattened conformation.

In various embodiments, liners of the present invention comprise a water-resistant, elastomer-coated mesh material, such mesh material being constructed of polymeric material having some inherent elasticity, such as polyester or nylon. A warp knit mesh construction is preferred in certain embodiments. The mesh material also may be steel mesh, preferably hexagonal netting of drawn steel wire or similar high modulus material, such as extended-chain crystallized polymer.

In another embodiment, a system whereby use is made of a double bottom tank, in fluid communication with a bag made of reinforced elastomeric material to provide segregated ballast space in the cargo space of a ship. The double bottom space and bag are filled with ballast water when the cargo space is empty, thereby making use of the cargo space in which the bag is located to carry ballast water in space previously occupied by cargo, without having any cross-contamination of the ballast water by the cargo residues or gases. The outward and upward movement of the bag is restricted by a rigid guide cage. An open, or partially open, topped rigid container is placed around the guide cage to restrict the “free surface effect” of the ballast water in the unlikely event of failure of the ballast bag. A header tank is provided to keep a positive pressure head on the water in the bag when in the ballast condition. A semi-flexible float assists in guiding the bag during ballasting and de-ballasting operations. Furthermore, fresh or potable water could be used in the place of ballast water. The fresh or potable water would function as ballast water and is delivered to the destination uncontaminated by the oil residue remaining in the oil tanks. By way of example and in further support of the present disclosure, U.S. Pat. No. 4,409,919 to Strain issued on Oct. 18, 1983, is incorporated herein by reference in its entirety.

In another embodiment, methods for optimizing the transportation of cargo, such as oil and water, are employed to further reduce costs, achieve the most economical transport of water to water starved regions and to coordinate tanker availability around the globe for such purposes. By way of example and in further support of the optimization methods available in the present disclosure, U.S. Patent Application Publication No. 2010/0287073 to Kocis is incorporated herein by reference in its entirety. Thus in one embodiment, the present method employs a process for optimal transporting of water that includes optimizing a plurality of transportation decisions and mechanically transporting water through movement of a plurality of water going vehicles in accordance with a set of optimized transportation decisions, including transportation routes and schedules for oil tankers, allocation of water to be transported to one or more demand locations by the transportation vehicles, and nomination of water pickup by the oil tankers, with such decisions optimized by collecting data relating to the various transportation decisions, using the data collected as part of a mixed integer linear programming model, and obtaining a solution to the model to arrive at a set of optimized transportation decisions.

One aspect of the present invention is directed to identifying surface currents, particularly along particular coasts, to determine those currents that are favorable to vessels transporting or towing bulk containers of non-salt water, preferably fresh water (whether or not contaminated by oil residue from an oil tanker's last shipment of oil). Vessels transporting bulk fresh water may include a combination of tankers and very large bags (VLB's). As described herein, the combined usage of tankers and VLB's facilitates the long-felt but unsolved need of conveying non-salt water to regions of the globe in need thereof. Such a system and method, for example, can be employed to recharge the over-taxed aquifers of some Pacific islands until they are able to regain their sustainable hydrostatic pressure.

It is important in many embodiments of the present invention to properly gauge the currents through which both tankers and VLB may traverse so as to achieve desired efficiencies of energy use, avoid catastrophic episodes related to adverse ocean conditions, etc. For example, the present inventors have first appreciated that the traditionally mean currents of the Humboldt Current will not provide adequate, useful estimates of the surface currents for the transporting vessels. Historical satellite-tracked surface drifters deployed in the Pacific Ocean may show the seasonal variable character of the surface currents, but are deemed to be inadequate to accurately predict the near surface current in real time. Thus, obtainment and use of computer model results that predict global surface currents forced by real time satellite sensed winds and sea level height anomalies, which are available in real time, provides a better estimate of the near surface current for the transporting vessels. In certain embodiments, the use of satellite-tracked drifter along a vessel's course is employed to provide valuable additional information of the current for a particular voyage. In addition or in lieu thereof, long-range radar instrumentation may be installed along the subject coastline(s) to further provide useful maps of the currents. Specifically, the ability to track bodies and debris, e.g. which led to the successful location of Air France 447 on the sea floor at a depth of 3900 m in the Equatorial Atlantic Ocean, can be used to predict real time surface currents.

In certain embodiments, data from satellite-tracked surface drifters deployed during 1980 to the present in the Pacific Ocean are employed in a high-tech version of the “message in a bottle”. Using a surface buoy and a subsurface drogue (sea anchor), attached by a long, thin tether, the buoy measures location, temperature and other properties, and has a transmitter to send the data to passing satellites. The drogue dominates the total area of the instrument and is centered at a depth of 15 meters beneath the sea surface. The drifters are minimally affected by the wind and give direct estimates of the near-surface velocity. The velocity at the surface of the open ocean is nearly the same as the velocity at a depth of 15 m because there is normally a near surface mixed layer 10 s of meters thick in the upper ocean. A real time estimate of surface currents is useful to tanker ships transporting water—as well as VLB associated therewith, and is best accomplished by the use of direct observations and output from real-time computer models of the ocean. These modern computer models are similar to the models that have been developed to predict the weather. Real time satellite wind products using microwaves and real time ship observations and state of the art real time models of ocean circulation are thus employed to determine preferred routes of transport so as to avoid obstacles, conserve energy and to protect the delicate nature of VLB conveyance.

In certain embodiments, a plot is produced in real time and sent to a vessel prior to departure or conveyed to a vessel at sea. In one embodiment, a five-day average current is the highest frequency output from the model, but consecutive five-day segments can overlap. A color bar showing color contours can be presented to represent the surface current speed with arrows and arrow lengths employed to represent the direction and speed. Sea surface height reflects the distribution of pressure in the ocean and the pressure gradients drive the ocean currents similar to how atmospheric pressure gradients drive the wind. Examples of such data can be obtained from the Ocean Surface Currents Analyses-Real Time (OSCAR) database at the National Oceanic and Atmospheric Administration (NOAA).

In various embodiments, methods and systems for conveying water in, over, and under land are provided. For example, in various embodiments, it is contemplated to utilize pre-existing easements and/or passageways, such as railway easements, for conveying water or similar liquid products of value to various locations. In one embodiment, a novel trench-digging system is provided on one or more portions of a railway car. By way of example, and for further enabling support of the present disclosure, the following references are hereby incorporated by reference in their entireties: U.S. Pat. Nos. 4,713,898 to Bull et al., 4,563,826 to Whitaker Jr., 4,890,958 to Dancer, 4,736,534 to Daniels et al., and 3,967,396 to Maisonneuve et al.

As a practical matter, one will appreciate that the large and economically well-off oil industry, using the present invention, may play a critical role in advancing the transport of desperately needed water resources to nation-states where water is scarce. Thus, while oil rich nations and large oil companies are typically the favorite despised entities due to the profits inherent in the oil trade, the prospect of employing the present invention by these very entities provides a meaningful commercial and public relations opportunity that demonstrates how the existing oil industry infrastructure can be used to provide water to water-sensitive regions of the world so as to eliminate long-felt hardships by millions of people and in a manner that may very well avoid future military conflicts based on the destruction of desalinization plants in a water-dependent nation.

Various embodiments of the present invention include a system and a method for storing bags, a method for trading water, and a method of shipping water by employing preexisting tanker vessels. Representative figures for each of these are incorporated herein by this reference to PCT Application No. PCT/US2010/052864. (See figures therein).

What is claimed is:

1. A method of preparing water from an ice source, the method comprising:
(a) selecting a water source comprising water in the form of ice, wherein the water has at least one desirable characteristic;
(b) conducting water from the ice source through at least one filter, wherein the at least one filter comprises clay;
(c) identifying at least three additional characteristics of the water.

2. The method of claim 1, wherein the ice comprises at least 1000 cubic meters (m³).

3. The method of claim 1, wherein the source of ice is selected from the group consisting of an ice cap, a glacier, and an iceberg.

4. The method of claim 1, wherein the desirable characteristic is that the ice is substantially free of at least one material selected from the group consisting of nitrate, nitrite, mercury, lead, arsenic, cadmium, benzene, chlorine, chromium, tetrachloroethylene, trichloroethylene, uranium, 2,4-Dichlorophenoxyacetic Acid (2,4-D), dichlorobenzene, polychlorinated biphenyls (PCBs), trihalomethanes (THMs) and volatile organic compounds (VOCs).

5. The method of claim 4, wherein the ice is substantially free of at least three such materials.

6. The method of claim 1, wherein the additional characteristics are selected from the group consisting of: pH, acidity, geographic location, geological period, quality, source, purity, geological formation, treatment regimen, latitudinal characteristics, mineral content, and extraterrestrial content.

7. The method of claim 6, further comprising packing the water for distribution in containers that display information regarding the additional characteristics in the water.

8. The method of claim 1, wherein the water from the ice source comprises a quantity of glycine.

9. The method of claim 1, wherein the water is conducted through the at least one filter using gravitational energy.

10. The method of claim 1, wherein the step of filtering comprises one or more filters comprising a permeability between approximately 10⁻¹⁰ cm/s and approximately 10⁻³ cm/s.

11. The method of claim 1, wherein the water has at least one characteristic similar to at least one characteristic of water derived from a sub-polar ice field located approximately between 15 and 60 degrees south latitude.

12. A method for trading water, the method comprising:
(a) connecting a first entity desiring to obtain water having at least one specific characteristic with a second entity having possession of a source of water comprising the at least one specific characteristic;
(b) conveying from the first entity to the second entity information relating to the amount and characteristic of the desired water;
(c) based on the information conveyed, transferring a right to an amount of water having the desired specific characteristic that the second entity is willing to transfer, from the second entity to the first entity, wherein the second entity receives compensation in an amount related to the amount of water covered by the transferred right;
wherein the water possessed by the second entity is sequestered as ice.

13. The method of claim 12, wherein the specific characteristic is selected from the group consisting of being from a specific geological time period, having a specific purity, comprising a specific nutrient, and having been purified by filtration through native soils.

14. The method of claim 12, wherein the water is substantially free of at least one material selected from the group consisting of nitrate, nitrite, mercury, lead, arsenic, cadmium, benzene, chlorine, chromium, tetrachloroethylene, trichloroethylene, uranium, 2,4-Dichlorophenoxyacetic Acid (2,4-D), dichlorobenzene, polychlorinated biphenyls (PCBs), trihalomethanes (THMs) and volatile organic compounds (VOCs)

15. The method of claim 12, wherein the second entity has ownership in the water comprising the at least one specific characteristic.

16. The method of claim 12, wherein the step of conveying is performed using an electronic device.

17. The method of claim 12, wherein the step of conveying comprises using an exchange.

18. The method of claim 12, wherein the right is selected from the group consisting of the right to an option to obtain title to an amount of water, the right to use offer an amount of water as an asset, and the right to obtain title to an amount of water.

19. The method of claim 12, wherein the right is title to an amount of water.

20. The method of claim 12, wherein following transfer of title, an amount of water covered by the title is recovered from the ice.

21. The method of claim 12, further comprising:
(d) transferring physical possession of the water to the first entity.

22. The method of claim 12, wherein the water is transferred to a geographic location different from the location at which it is possessed by the second entity.

23. The method of claim 12, wherein physical transfer of the water comprises a tanker or bag.

24. The method of claim 23, wherein the tanker vessel was previously adapted for transporting oil or liquid natural gas.

25. A method of delivering non-salt water to a destination utilizing oil tankers, the method comprising:
(a) providing an oil tanker with cargo comprising oil at a first location and having a second location as a destination port for delivery of the oil, wherein said oil is delivered at said destination port and substantially all of the oil within the oil tanker is emptied from the oil tanker, except for residual oil residue left behind;
(b) substantially filling the oil tanker with non-salt water in both a ballast section of the oil tanker and in a second section of the oil tanker that previously held oil for transport;
(c) at least partially treating said non-salt water contained in said oil tanker while en route to said second destination, said water treatment selected from the group consisting of at least two of the following:
(d) filtering through a natural clay filter; centrifugation; reverse osmosis;
gravity separation; contact with a natural coagulant; adjusting pH to between about 6 to about 11; and ozonation; and
(e) segregating water treated in accordance with step d) from water that has not been treated in accordance with step d), said segregation accomplished by at least one of: conveying said water treated in accordance with step d) to a substantially oil-free storage section of the oil tanker; and conveyance of said water treated in accordance with step d) to a very large bag adapted for containing water.

26. The method of claim 25, wherein upon arrival at said second location, said water treated in accordance with step d) is further treated to remove oil therefrom.

27. A method for conveying fluids, said method comprising:
(a) a non-rigid, water-impermeable device with an elongate shape having a first end, a second end and having a generally planar and streamlined shape in plain view;
the first end comprising a first attachment device;
the second end comprising a second attachment device;
a plurality of ports for the intake and exhaust of fluids;
at least one of the plurality of ports comprising a valve for the user selected increase of buoyancy of the system;
at least one of the plurality of ports comprising a valve for the user selected decrease of buoyancy of the system;
at least a portion of the device containing a fluid of lower density than a fluid to be transported;
(b) one or more valves in two-way communication with at least a portion of an interior volume of the system and an outside environment;
(c) a transmitter for conveying information related to the geographic position of the system;
(d) visual indicia for communicating with other vessels proximal to the system;
at least a portion of an internal surface area of the system being comprised of a material distinct from the remainder of the system;
(e) a mooring device;
(f) an anchored member having a first end, a second end, and a longitudinal length disposed in a vertical position;
a translatable device disposed on the longitudinal length of the anchored member;
securing the first attachment device of the first end to the mooring device;
securing the second attachment device of the second end to the translatable device disposed on the longitudinal length of the anchored member; and
lowering the translatable device to a submerged position and positioning the system in a substantially vertical position.

28. A method of shipping comprising:
a first location;
second location; and
a shipping vessel, wherein:
said first location comprises substantial quantities of natural gas;
said second location comprises substantial quantities of water;
said shipping vessel is provided with cargo comprising natural gas at said first location and transported to said second location;
said shipping vessel is at least partially emptied of said cargo comprising natural gas and modified such that said vessel is adapted for transporting water without subjecting the water to natural gas;
providing said vessel with cargo comprising water at said second location; and
wherein said shipping vessel is transported from said second location to said first location.
